(19) United States
(12) Patent Application Publication
(10) Pub. No.: US 2011/0256420 A1
(43) Pub. Date: Oct. 20, 2011

(54) HOT-DIP GALVANIZED STEEL PLATE AND PRODUCTION METHOD THEREOF

(75) Inventors: Wei Li, Sichuan (CN); Quan Xu, Sichuan (CN); Taixiong Guo, Sichuan (CN); Zhiwang Zheng, Sichuan (CN); Dan Yu, Sichuan (CN); Yilin Zhou, Sichuan (CN)

(73) Assignees: PANGANG GROUP STEEL VANADIUM & TITANIUM CO., LTD., Panzhihua, Sichuan (CN); PANGANG GROUP PANZHIHUA IRON & STEEL RESEARCH INSTITUTE CO., LTD., Panzhihua, Sichuan (CN); PANGANG GROUP RESEARCH INSTITUTE CO., LTD., Chengdu, Sichuan (CN)

(21) Appl. No.: 13/003,619

(22) PCT Filed: Jul. 30, 2009
(86) PCT No.: PCT/CN2009/073004

§ 371 Date: Jul. 5, 2011

(30) Foreign Application Priority Data
Jul. 30, 2008 (CN) 200810303233.3
Jul. 31, 2008 (CN) 200810303257.9
Jul. 31, 2008 (CN) 200810303258.3
Jul. 31, 2008 (CN) 200810303272.3

(51) Int. Cl. B32B 15/01; B05D 3/02

(52) U.S. Cl. 428/659; 427/321

(57) ABSTRACT

The invention provides a hot-dip galvanized steel plate with high adhesion between a plating layer and base steel, and belongs to the field of manufacturing hot-dip galvanized steel plates. Atomic concentration ratio Al/Zn of Al and Zn in a Fe-Al intermediate transition layer between a base steel and a plating layer of the hot-dip galvanized steel plate is 0.9-1.2. The plating layer did not have Γ phase, but has relatively thin δ phase and little ξ phase. The plating layer mostly consists of η phase, thus obviously improving adhesion, scratch resistance and wear resistance of the plating layer.

### FIELD OF THE INVENTION

The invention belongs to the field of manufacturing hot-dip galvanized steel plates, in particular relates to a hot-dip galvanized steel plate with good adhesion of the plating layers and a production method thereof.

### DESCRIPTION OF THE RELATED ART

Hot-dip galvanized steel plates are widely applied to the manufacturing industry such as household appliance and automobile body plates due to good corrosion resistance, excellent coating and plating performance and clean appearance. Plating layers of the hot-dip galvanized steel plates are required to have strong adhesion of the plating layers and base plates to prevent dropout in case of deformation due to stamping and good welding performance, corrosion resistance and phosphatizing performance to ensure adhesion of paint film and corrosion resistance after painting. However, the hot-dip galvanized steel plates has problems of pulverization and stripping of the plating layer in stamping and machining process in practical application, damaging the plating layer and further affecting corrosion resistance and adhesion of the plating layer.

Chinese patent (publication No.: CN17011130A; and publication date: Nov. 23, 2005) and Japanese patents (Kokai patent publication No. 2002-4019 and Kokai patent publication No. 2002-4020) disclose methods for controlling surface roughness of hot-dip galvanized steel plates to prevent adhesion of metal dies in stamping and forming, and methods for improving deep drawability. However, detailed studies on such hot-dip galvanized steel plates show that adhesion with the metal die can be controlled for short friction distance from the metal die, but the adhesion is smaller while the friction distance is longer, and sometimes improvement effect can not be achieved due to different friction conditions. In addition, a method for controlling a finishing roller, rolling conditions, etc. can be deduced from the method for improving roughness in the proposals. However, in effect, zinc is easily piled and blocked on rollers, thus it is hard to form desired roughness on the surfaces of such hot-dip galvanized steel plates. In addition, Japanese patent (Koho patent publication No. 2993404) provides a process for improving adhesion of the plating film by using P-added steel containing 0.010-0.10mt % of P and 0.05-0.20 wt % of Si with Si not less than P to parent metal. However, the technique does not surely improve adhesion of the plating film for other steel plates without P. Japanese patent (Kokai patent publication No. 2001-335908) discloses the following technique: when the parent metal is low-carbon steel with 0.05-0.25wt % of C and high-strength retained austenite steel with a proper amount of Si and Al added, a proper amount of Ti, Nb, etc. are added to the steel for fixing grain boundary C to improve plating boundary strength. However, the technique relates to the retained austenite steel and is not surely effective in obtaining adequate performance for high-strength steel plates without retained austenite phase.

Adhesion of the plating layer of the galvanized steel plates is also mainly affected by composition and structure of the plating layer in addition to composition and process conditions of the base steel plates. The pulverization and the stripping are related to chemical composition and phase structure of the plating layer, and pulverization amount of the plating layer increases as iron content of the plating layer increases. The interface between the steel plate and the zinc layer is Γ phase, δ phase, ζ phase and η phase successively. The Γ phase is an intermetallic phase based on Fe₅Zn₂₁, the δ phase is an intermetallic phase based on FeZn₇, the ζ phase is an intermetallic phase based on FeZn₁₃, and the ζ phase is solid solution consisting of pure zinc and containing trace iron. The pulverization of the plating layer means that microcrack forms on an interface at two sides of the Γ phase and extends through the plating layer. When the thickness of the F phase exceeds 1.0um, the pulverization amount increases as the thickness of the Γ phase increases. Formation of thick Γ phase can be blocked if the iron content of the plating layer can be controlled to be about 11%. Therefore, main influencing factors of anti-pulverization performance are the δ phase (fine-grained structure) and the ζ phase (columnar structure). The δ phase is rigid and fragile and is unfavorable to formability. The ζ phase has comparable hardness with the base steel plates, and is favorable to releasing residual stress from the plating layer. However, the ζ phase is easily adhered to the dies due to high toughness thereof, causing surface defect or stripping of the plating layer. Therefore, the plating layer can have good formability only when the ζ phase and the δ phase therein have proper proportion. The plating structure with uneven compact δ phase failing to appear upon disappearance of the ξ phase on the surface thereof is the best.

In practice, Al is often added to liquid zinc for improving the toughness of the plating layer, and Al content of a Fe-Al intermediate transition layer between base steel and the zinc layer of the hot-dip galvanized steel plate is an important factor for measuring adhesion strength of the plating layer. However, high Al content of the Fe-Al intermediate transition layer is necessary but insufficient to achieve good adhesion of the plating layer, as the Fe-Al intermediate transition layer can have adhesive action, prevent diffusion of Fe and Zn elements and form a thin Fe-Zn alloy layer with a little δ phase and ζ phase only when zinc unsaturatedly dissolves and forms lean zinc solid solution in the Fe-Al intermediate transition layer, under which the plating layer has better adhesion. If Zn has supersaturated solubility and forms rich zinc solid solution in the Fe-Al intermediate transition layer, the absolute content of Al in the intermediate transition layer does not reduce, but weight percentage of Al significantly reduces. Meanwhile, zinc supersaturation damages homogeneity of the Fe-Al intermediate transition layer, thus causing the intermediate transition layer to lose adhesive action and preventing diffusion of the Fe and Zn elements, and forming thicker Fe-Zn alloy layer with much δ phase and ζ phase, simultaneously damaging the adhesion of the zinc layer. In the prior art, the adhesion between the plating layer and the base steel is improved by a technique of forming a film on surface by changing the composition of the steel plates or controlling the surface roughness of the hot-dip galvanized steel plate, but the effect is not better. At present, there is no report on any method available for improving the adhesion between the plating layer and the base steel by controlling the composition and the structure of the plating layer.

### SUMMARY OF THE INVENTION

The first technical problem to be solved by the invention is to provide a hot-dip galvanized steel plate with high adhesion between a plating layer and base steel.

The technical proposal for solving the technical problem is as follows: atomic concentration ratio Al/Zn of Al and Zn in a Fe-Al intermediate transition layer between base steel and a plating layer of the hot-dip galvanized steel plate is 0.9-1.2.

The invention further provides a hot-dip galvanized steel plate with high adhesion between a plating layer and base steel and better plating structure. Atomic concentration ratio Al/Zn of Al and Zn in a Fe-Al intermediate transition layer between base steel and a plating layer of the hot-dip galvanized steel plate is 0.9-1.2, and intensity of grain orientation Zn(002) peak of the plating layer is 25000-35000 cts.

The second technical problem to be solved by the invention is to provide a production method of a hot-dip galvanized steel plate. Atomic concentration ratio Al/Zn of Al and Zn in a Fe-Al intermediate transition layer between base steel and a plating layer of the steel plate produced by the method is 0.9-1.2.

The technical proposal for solving the technical problem is as follows: a steel plate is pickled, annealed and hot-dip galvanized. During the hot-dip galvanization operation, temperature of the steel plate is 455-465° while being sent to plating bath, temperature of the plating bath in a zinc pot is 450-460°, weight percentage of Fe in the plating bath is less than 0.03%, weight percentage of Al in the plating bath is 0.16-0.25%, speed of a unit is 100-120 m/min, high-span temperature of a cooling section is 210-245°, and cooling rate of the steel plate is 0-90%.

Preferred proposal 1: a production method of a hot-dip galvanized steel plate comprises pickling and annealing a steel plate for hot-dip galvanization operation. During the hot-dip galvanization operation, temperature of the steel plate is 455-465° while being sent to plating bath, temperature of the plating bath in a zinc pot is 450-460°, weight percentage of Fe in the plating bath is less than 0.03%, weight percentage of Al in the plating bath is 0.16-0.18%, speed of a unit is 100-110 m/min, high-span temperature of a cooling section is 210-220°, and cooling rate of the steel plate is 0%.

Preferred proposal 2: a production method of a hot-dip galvanized steel plate comprises pickling and annealing a steel plate for hot-dip galvanization operation. During the hot-dip galvanization operation, temperature of the steel plate is 475-485° while being sent to plating bath, temperature of the plating bath in a zinc pot is 450-460°, weight percentage of Fe in the plating bath is less than 0.03%, speed of a unit is 100-110 m/min, cooling rate of the steel plate is 0%, high-span temperature of a cooling section is 235-245°, and weight percentage of Al in the plating bath is not less than 0.16% but not more than 0.18%.

Preferred proposal 3: a production method of a hot-dip galvanized steel plate comprises pickling and annealing a steel plate for hot-dip galvanization operation. During the hot-dip galvanization operation, temperature of the steel plate is 475-485° while being sent to plating bath, temperature of the plating bath in a zinc pot is 450-460°, weight percentage of Fe in the plating bath is less than 0.03%, weight percentage of Al in the plating bath is more than 0.18% but not more than 0.21%, speed of a unit is 100-110 m/min, cooling rate of the steel plate is 0%, and high-span temperature of a cooling section is 235-245°.

Preferred proposal 4: a production method of a hot-dip galvanized steel plate comprises pickling and annealing a steel plate for hot-dip galvanization operation. During the hot-dip galvanization operation, temperature of the steel plate is 455-465° while being sent to plating bath, temperature of the plating bath in a zinc pot is 450-460°, weight percentage of Fe in the plating bath is less than 0.03%, weight percentage of Al in the plating bath is 0.16-0.18%, speed of a unit is 110-120 m/min, and the steel plate is forcibly cooled by air cooling at the cooling rate of 70-90% after being taken out of the zinc pot (for natural cooling at the cooling rate of 0% when all cold air nozzles are closed, opening ratio of the cold air nozzles is 70-90%).

Preferred proposal 5: a production method of a hot-dip galvanized steel plate comprises pickling and annealing a steel plate for hot-dip galvanization operation. During the hot-dip galvanization operation, temperature of the steel plate is 455-465° while being sent to plating bath, temperature of the plating bath in a zinc pot is 450-460°, weight percentage of Al in the plating bath is 0.21-0.25%, weight percentage of Fe in the plating bath is less than 0.03%, speed of a unit is 100-110 m/min, cooling rate of the steel plate is 0%, and high-span temperature of a cooling section is 235-245°.

Further, the steel plate to be galvanized contains 0.03-0.07% of C, 0.01-0.03% of Mn, 0.19-0.30% of Si, 0.006-0.019% of P, 0.009-0.020% of S, 0.02-0.07% of Al and Fe based on weight percentage.

Thickness of the steel plate to be galvanized is 0.8 mm, weight of a zinc layer is 180-195 g/m² after galvanization, and surface of the zinc layer is subject to SiO₂ passivation treatment.

The invention has the following advantages:

(1) hot-dip galvanization process conditions of the invention cause the Fe-Al intermediate transition layer between the base steel and the plating layer to prevent mutual diffusion of Fe and Zn and reduce formation of the Fe-Zn alloy layer, and the plating layer does not have Γ phase, but has relatively thin δ phase and a little ξ phase, and the plating layer mostly consists of the η phase, which improve adhesion of the plating layer of the hot-dip galvanized steel plate, and reduces dropout, stripping, etc. of zinc powder thereof;

(2) the hot-dip galvanization process conditions of the invention help optimize grain orientation of the plating layer of the hot-dip galvanized steel plate, and obviously improve scratch resistance, wear resistance and adhesion of the plating layer; and

(3) the hot-dip galvanization production process of the invention is simple and has low cost.

### BRIEF DESCRIPTION OF THE DRAWINGS

FIG. 1 shows a spectrum surface scanning chromatogram of section of a plating layer of experimental example 1 by an electronic probe (model: EPMA1600).

FIG. 2 shows cross-section morphologies of the plating layers in experimental example 1 and comparative examples 6 and 11 by a scanning electron microscope (SEM), (a) represents experimental example 1; (b) represents comparative example 6; and (c) represents comparative example 11.

FIG. 3 shows metallographs by a 100× optical metallographic microscope (model: OLYMPUS BX51), (a) represents experimental example 1 and (b) represents comparative example 6.

FIG. 4 shows a schematic diagram of atomic percentage variations of Al and Zn elements of the Fe-Al intermediate transition layers of the plating layers of experimental example 1 and comparative examples 6 and 11.

FIG. 5 shows a schematic diagram of average atomic percentage variations of the Al and Zn elements at positions 2 to 4 in the Fe-Al intermediate transition layers (as shown in FIG. 1) of the plating layers of experimental examples 1 to 5 and comparative examples 6 to 10 and 11 to 15.

FIG. 6 shows mass percentage variations of the Fe, Zn and Al elements at various positions (as shown in FIG. 1) from base steel to the zinc layer surface in the plating layers of experimental example 1 and comparative examples 6 and 11 and metallographic structures of the plating layers, (a) represents experimental example 1; (b) represents comparative example 6; and (c) represents comparative example 11.

FIG. 7 shows typical XRD diffraction patterns of experimental example 1 and comparative examples 6 and 11, (a) represents experimental example 1, (b) represents comparative example 6 and (c) represents comparative example 11.

FIG. 8 shows a schematic diagram of shape of a U-shaped bending sample, 1 represents a bending tester clamp; and 2 represents a bending sample.

FIG. 9 shows dropout means and variances of zinc powder of samples of experimental examples 1 to 5 and comparative examples 6 to 10 and 11 to 15.

FIG. 10 shows a typical profile survey map of middle scratch positions of the plating layers of experimental example 1 and comparative examples 6 and 11, 1 represents experimental example 1, 2 represents comparative example 6 and 3 represents comparative example 11.

FIG. 11 shows a general view of wear marks observed under SEM after reciprocating sliding wear tests of the plating layers of experimental example 1 and comparative examples 6 and 11.

FIG. 12 shows atomic percentage variations of the Al and Zn elements of the Fe-Al intermediate transition layers in the plating layers of experimental example 16 and comparative example 21.

FIG. 13 shows average atomic percentages of the Al and Zn elements of the Fe-Al intermediate transition layers in the plating layers of experimental examples 16 to 20 and comparative examples 21 to 25.

FIG. 14 shows mass percentage variations and metallographic structures of the Fe, Zn and Al elements of the plating layers of experimental example 16 and comparative example 21, (a) represents experimental example and (b) represents comparative example 21.

FIG. 15 shows typical XRD diffraction patterns of experimental example 16 and comparative example 21, (a) represents experimental example 16 and (b) represents comparative example 21.

FIG. 16 shows dropout means and variances of zinc powder of experimental examples 16 to 20 and comparative examples 21 to 25.

FIG. 17 shows profile survey results of middle scratch positions of the plating layers of experimental example 16 and comparative example 21, 1 represents comparative example 21 and 2 represents experimental example 16.

FIG. 18 shows typical XRD diffraction patterns of experimental examples 21 and 26 and comparative examples 26 and 30, (a) represents experimental example 21; (b) represents experimental example 26; (c) represents comparative example 26; and (d) represents comparative example 30, ordinate represents diffraction intensity, and abscissa represents 2θ/°.

FIG. 19 shows dropout means and variances of zinc powder of experimental examples 21 to 30, comparative examples 26 to 30 and comparative examples 31 to 35.

FIG. 20 shows profile survey results of middle scratch positions of the plating layers of experimental examples 21 and 26 and comparative examples 26 and 30, 1 represents experimental example 21; 2 represents experimental example 26; 3 represents comparative example 26; and 4 represents comparative example 30.

FIG. 21 shows atomic percentage variations of the Al and Zn elements of the Fe-Al intermediate transition layers in the plating layers of experimental example 31 and comparative example 36.

FIG. 22 shows average atomic percentages of the Al and Zn elements of the Fe-Al intermediate transition layer in the plating layers of experimental examples 31 to 35 and comparative examples 36 to 40.

FIG. 23 shows mass percentage variations and metallographic structures of the Fe, Zn and Al elements in the plating layers of experimental example 31 and comparative example 36, (a) represents experimental example 31 and (b) represents comparative example 36.

FIG. 24 shows typical XRD diffraction patterns of experimental example 31 and comparative example 36, (a) represents experimental example 31 and (b) represents comparative example 36.

FIG. 25 shows dropout means and variances of zinc powder of experimental examples 31 to 35 and comparative examples 36 to 40.

FIG. 26 shows profile survey results of middle scratch positions of the plating layers of experimental example 31 and comparative example 36: 1 comparative example 36 and 2 experimental example 31.

FIG. 27 shows atomic percentage variations of the Al and Zn elements of the Fe-Al intermediate transition layers in the plating layers of experimental example 36 and comparative example 41.

FIG. 28 shows average atomic percentages of the Al and Zn elements of the Fe-Al intermediate transition layers in the plating layers of experimental examples 36 to 42 and comparative examples 41 to 47.

FIG. 29 shows mass percentage variations and metallographic structures of the Fe, Zn and Al elements in the plating layers of experimental example 36 and comparative example 41, (a) represents mass percentage variation of experimental example 36, (b) represents metallographic structure of experimental example 36, (c) represents mass percentage variation of comparative example 41, and (d) represents metallographic structure of comparative example 41.

FIG. 30 shows dropout means and variances of zinc powder of experimental examples 36 to 42 and comparative examples 41 to 47.

FIG. 31 shows profile survey results of middle scratch positions of the plating layers of experimental examples 36 and comparative examples 41, 1 represents experimental example 36; and 2 represents comparative example 41.

### DETAILED DESCRIPTION OF THE PREFERRED EMBODIMENTS

The invention will be further described in conjunction with the following embodiments. The examples are only for illustration rather than limiting the invention in any way.

Atomic concentration ratio Al/Zn of Al and Zn in a Fe-Al intermediate transition layer between base steel and a plating layer of the hot-dip galvanized steel plate of the invention is 0.9-1.2. Further, intensity of grain orientation Zn(002) peak of the plating layer is 25000-35000 cts.

A specific production method of the hot-dip galvanized steel plate is as follows:

A steel plate is pickled and annealed for hot-dip galvanization operation. During the hot-dip galvanization operation, temperature of the steel plate is 455-485° while being sent to plating bath, temperature of the plating bath in a zinc pot is 450-460°, weight percentage of Fe in the plating bath is less than 0.03%, weight percentage of Al in the plating bath is 0.16-0.25%, speed of a unit is 100-120 m/min, high-span temperature of a cooling section is 210-245°, and cooling rate of the steel plate is 0-90%. The section at which the galvanized steel plate is drawn from the zinc pot and moved vertically and upwardly to a first deflecting roller of a cooling tower is called a precooling section (generally 15-30 m). To freeze the plating layer in front of the first deflecting roller, a row of cold air nozzles are arranged against an air knife thereabove for forced cooling by blowing cold air. A horizontal cooling section that strip steel enters the cooling tower by the first deflecting roller is called a high-span section which is provided with 4 sets of air boxes for adjusting temperature. High-span temperature is the temperature of the conveyed steel plate when entering the high-span section.

Preferred proposal 1: a production method of a hot-dip galvanized steel plate comprises pickling and annealing a steel plate for hot-dip galvanization operation. During the hot-dip galvanization operation, temperature of the steel plate is 455-465° while being sent to plating bath, temperature of the plating bath in a zinc pot is 450-460°, weight percentage of Fe in the plating bath is less than 0.03%, weight percentage of Al in the plating bath is 0.16-0.18%, speed of a unit is 100-110 m/min, high-span temperature of a cooling section is 210-220°, and cooling rate of the steel plate is 0%. In the production method of the hot-dip galvanized steel plate, Al/Zn ratio of a Fe-Al intermediate transition layer is controlled by the high-span temperature of the cooling section in the hot-dip galvanization process to reduce formation of a Fe-Zn alloy layer and improve adhesion of a plating layer. 0% cooling rate of the steel plate means that all cold air nozzles are closed at the precooling section and natural cooling is performed only by heat radiation and convection. Atomic concentration ratio Al/Zn of Al and Zn in the Fe-Al intermediate transition layer between base steel and a plating layer produced by the method is 0.9-1.2.

Preferred proposal 2: a production method of a hot-dip galvanized steel plate comprises pickling and annealing a steel plate for hot-dip galvanization operation. During the hot-dip galvanization operation, temperature of the steel plate is 475-485° while being sent to plating bath, temperature of the plating bath in a zinc pot is 450-460°, weight percentage of Fe in the plating bath is less than 0.03%, speed of a unit is 100-110 m/min, cooling rate of the steel plate is 0%, high-span temperature of a cooling section is 235-245°, and weight percentage of Al in the plating bath is not less than 0.16% but not more than 0.18%. Atomic concentration ratio Al/Zn of Al and Zn in a Fe-Al intermediate transition layer between base steel and a plating layer produced by the method is 0.9-1.2, and intensity of grain orientation Zn(002) peak of the plating layer is 25000-35000 cts.

Preferred proposal 3: a production method of a hot-dip galvanized steel plate comprises pickling and annealing a steel plate for hot-dip galvanization operation. During the hot-dip galvanization operation, temperature of the steel plate is 475-485° while being sent to plating bath, temperature of the plating bath in a zinc pot is 450-460°, weight percentage of Fe in the plating bath is less than 0.03%, weight percentage of Al in the plating bath is more than 0.18% but not more than 0.21%, speed of a unit is 100-110 m/min, cooling rate of the steel plate is 0%, and high-span temperature of a cooling section is 235-245°. Atomic concentration ratio Al/Zn of Al and Zn in a Fe-Al intermediate transition layer between base steel and a plating layer produced by the method is 0.9-1.2, and Intensity of grain orientation Zn(002) peak of the plating layer is 25000-35000 cts.

In the first two production methods of the hot-dip galvanized steel plate, the Al/Zn ratio of the Fe-Al intermediate transition layer is controlled by temperature of the steel plate while being sent to plating bath in the hot-dip galvanization process so as to reduce formation of the Fe-Zn alloy layer, adjust optimum grain orientation of the plating layer and improve adhesion thereof.

Preferred proposal 4: a production method of a hot-dip galvanized steel plate comprises pickling and annealing a steel plate for hot-dip galvanization operation. During the hot-dip galvanization operation, temperature of the steel plate is 455-465° while being sent to plating bath, temperature of the plating bath in a zinc pot is 450-460°, weight percentage of Fe in the plating bath is less than 0.03%, weight percentage of Al in the plating bath is 0.16-0.18%, speed of a unit is 110-120 m/min, and the steel plate is forcibly cooled by air cooling at the cooling rate of 70-90% after being taken out of the zinc pot (for natural cooling at the cooling rate of 0% when all cold air nozzles are closed, opening ratio of the cold air nozzles is 70-90%). Atomic concentration ratio Al/Zn of Al and Zn in the Fe-Al intermediate transition layer between base steel and a plating layer produced by the method is 0.9-1.2, and intensity of grain orientation Zn(002) peak of the plating layer is 25000-35000 cts. In the production method of the hot-dip galvanized steel plate, the Al/Zn ratio of the Fe-Al intermediate transition layer is controlled by the cooling rate of the steel plate after being drawn from the zinc pot in the hot-dip galvanization process so as to reduce formation of a Fe-Zn alloy layer, adjust optimum grain orientation of the plating layer and improve adhesion thereof.

Preferred proposal 5: a production method of a hot-dip galvanized steel plate comprises pickling and annealing a steel plate for hot-dip galvanization operation. During the hot-dip galvanization operation, temperature of the steel plate is 455-465° while being sent to plating bath, temperature of the plating bath in a zinc pot is 450-460°, weight percentage of Al in the plating bath is 0.21-0.25%, weight percentage of Fe in the plating bath is less than 0.03%, speed of a unit is 100-110 m/min, cooling rate of the steel plate is 0%, and high-span temperature of a cooling section is 235-245°. Atomic concentration ratio Al/Zn of Al and Zn in a Fe-Al intermediate transition layer between base steel and a plating layer produced by the method is 0.9-1.2, and intensity of grain orientation Zn(002) peak of the plating layer is 25000-35000 cts. In the production method of the hot-dip galvanized steel plate, the Al/Zn ratio of the Fe-Al intermediate transition layer is controlled by Al content of the plating bath in the hot-dip galvanization process so as to reduce formation of a Fe-Zn alloy layer, adjust optimum grain orientation of the plating layer and improve adhesion thereof.

The steel plate to be galvanized contains 0.03-0.07% of C, 0.01-0.03% of Mn, 0.19-0.30% of Si, 0.006-0.019% of P, 0.009-0.020% of S, 0.02-0.07% of Al and Fe based on weight percentage.

Thickness of the steel plate to be galvanized is 0.8 mm, weight of a zinc layer is 180-195 g/m² after galvanization, and surface of the zinc layer is subject to SiO₂ passivation treatment.

### Example 1: Preparation and Performance Measurement of Experimental Examples 1 to 5 and Comparative Examples 6 to 15 of the Hot-Dip Galvanized Steel Plate

A DX51D cold-rolled steel plate which was 0.8 mm thick and contained 0.03-0.07% of C, 0.01-0.03% of Mn, 0.19-0.30% of Si, 0.006-0.019% of P, 0.009-0.020% of S, 0.02-0.07% of Al, Fe and inevitable impurities was pickled and annealed for hot-dip galvanization operation under various hot-dip galvanization process conditions listed in Table 1. Initial temperature of plating bath in a zinc pot was 450°, Fe content was less than 0.03% and Al content was 0.160-0.180% in the plating bath, speed of a unit was 100 m/min, high-span temperature of a cooling section was 240°, cooling rate was 0%, and temperature of the steel plate was adjusted to 475-485° while being sent to the plating bath for the hot-dip galvanization operation to obtain samples of examples 1 to 5; and temperature of the steel plate was respectively adjusted to 455-465° and 440-450° while being sent to the plating bath for hot-dip galvanization operation to obtain samples of comparative examples 6 to 10 and 11 to 15. Weight of a zinc layer was controlled to be 180-195 g/m², and surface of the zinc layer was subject to SiO₂ passivation treatment.

TABLE 1
Hot-dip galvanization process conditions

| | | | | Hot-dip galvanization process conditions | | | |
|---|---|---|---|---|---|---|---|
| | | | | | Temperature | | High-span |
| | | | Weight | Speed | of steel plate | Al content | temperature |
| | Steel | Thickness, | of zinc | of unit, | while being sent | of plating | of cooling |
| Test sample | grade | mm | layer, g | m/min | to plating bath, ° | bath, % | section, ° |
| Experimental | DX51D | 0.80 | 191 | 100 | 480 | 0.170 | 240 |
| example 1 | | | | | | | |
| Experimental | DX51D | 0.80 | 191 | 100 | 485 | 0.175 | 240 |
| example 2 | | | | | | | |
| Experimental | DX51D | 0.80 | 191 | 100 | 483 | 0.169 | 240 |
| example 3 | | | | | | | |
| Experimental | DX51D | 0.80 | 191 | 100 | 479 | 0.170 | 240 |
| example 4 | | | | | | | |
| Experimental | DX51D | 0.80 | 191 | 100 | 485 | 0.168 | 240 |
| example 5 | | | | | | | |
| Comparative | DX51D | 0.80 | 181 | 100 | 456 | 0.170 | 240 |
| example 6 | | | | | | | |
| Comparative | DX51D | 0.80 | 181 | 100 | 460 | 0.172 | 240 |
| example 7 | | | | | | | |
| Comparative | DX51D | 0.80 | 181 | 100 | 462 | 0.170 | 240 |
| example 8 | | | | | | | |
| Comparative | DX51D | 0.80 | 181 | 100 | 458 | 0.171 | 240 |
| example 9 | | | | | | | |
| Comparative | DX51D | 0.80 | 181 | 100 | 461 | 0.174 | 240 |
| example 10 | | | | | | | |
| Comparative | DX51D | 0.80 | 183 | 100 | 440 | 0.170 | 240 |
| example 11 | | | | | | | |
| Comparative | DX51D | 0.80 | 183 | 100 | 442 | 0.171 | 240 |
| example 12 | | | | | | | |
| Comparative | DX51D | 0.80 | 183 | 100 | 444 | 0.170 | 240 |
| example 13 | | | | | | | |
| Comparative | DX51D | 0.80 | 183 | 100 | 448 | 0.175 | 240 |
| example 14 | | | | | | | |
| Comparative | DX51D | 0.80 | 183 | 100 | 445 | 0.172 | 240 |
| example 15 | | | | | | | |

### Performance Measurement of Experimental Examples 1 to 5 and Comparative Examples 6 to 15 of the Hot-Dip Galvanized Steel Plate

(1) Fe-Al intermediate transition layers, cross-section morphologies and structures of plating layers

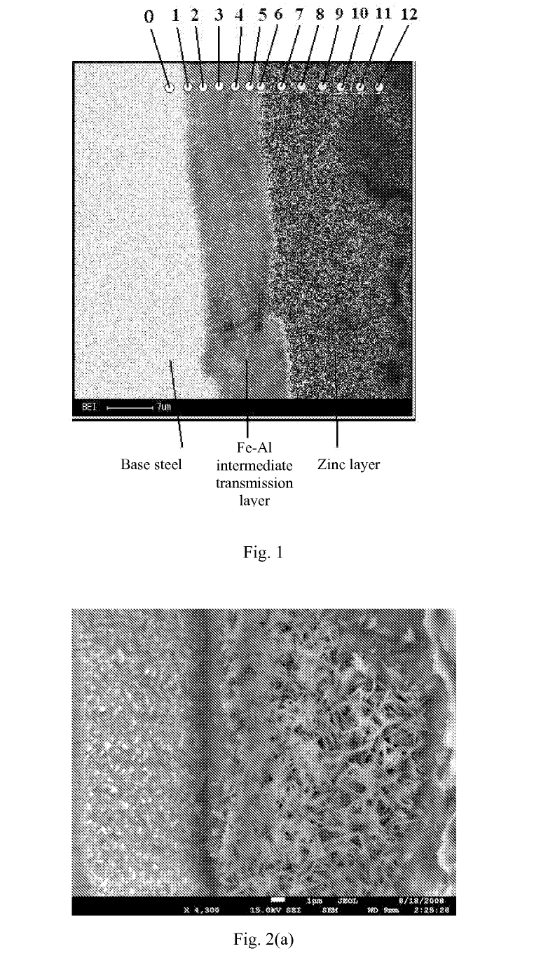

As thickness of Fe-Al intermediate transition layer ranged from dozens to hundreds of nanometers, the intermediate transition layers can hardly be shown by a conventional metallurgical sample preparation method. In the metallurgical sample preparation of the invention, oblique mounting was adopted and mounting material was bakelite powder. Three hot-dip galvanized steel plate samples were glued together by 502 super glue, arranged in parallel on an oblique block forming an inclination angle of 30° with a horizontal plane and then mounted on a hot mounting press. Visible range of the whole section of the ground and polished steel plate was increased approximately once, and the Fe-Al intermediate transition layers between interfaces of various plating layers and base steel were obviously shown. Atomic and mass percentage of various major elements in the Fe-Al intermediate transition layers of the plating layers were determined by virtue of spectrum surface scanning by an electronic probe (model: EPMA1600) and spot composition analysis. All samples used by EPMA were unetched metallurgical samples subject to the oblique mounting. EPMA surface scanning results showed that all experimental examples and comparative examples had dark black bands, i.e. the Fe-Al intermediate transition layers as shown in FIG. 1, their two sides were the base steel and the zinc layers respectively. Spectrum spot composition analysis was equidistantly performed on sections of the various plating layers of experimental examples and comparative examples from the base steel to the zinc layer surface, and specific positions were shown in FIG. 1. In FIG. 1, 0 represented position of the base steel, 1 to 5 represented positions of the Fe-Al intermediate transition layers, and 6-12 represented positions of the zinc layers.

In typical metallurgical samples of the plating layers, EPMA line scanning chromatogram measured by EPMA showed that Al element had the highest content in the intermediate transition layer, and Zn element content gradually increased and Fe element content gradually decreased from the base steel to the plating surface.

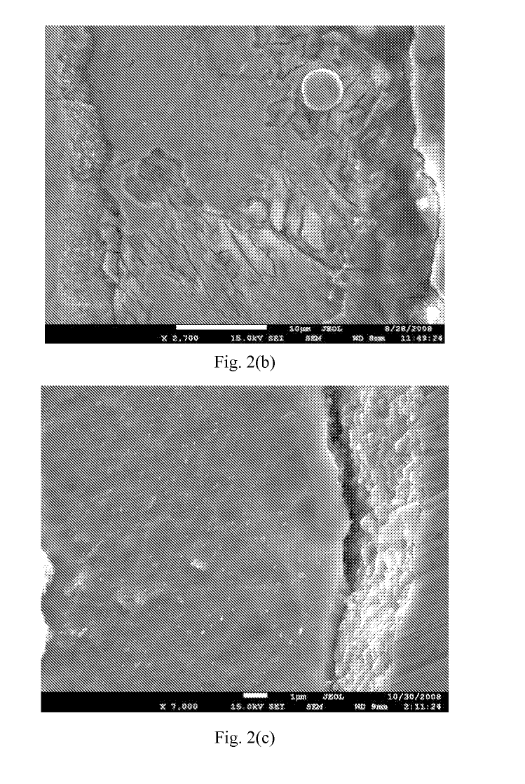

FIG. 2 shows cross-section morphologies of metallurgical samples of experimental example 1, comparative example 6 and comparative example 11 measured by scanning electron microscope (SEM). The Fe-Al intermediate transition layers with thickness ranging from dozens to hundreds of nanometers at interfaces between various zinc layers and base steel were obviously shown and had fine granular morphologies due to the oblique mounting. Width of the Fe-Al intermediate transition layers and the plating layers were not compared due to the oblique mounting. Experimental example 1 in the figure had fine and even pure zinc dendrite sectional shape; the plating layer of comparative example 6 had many cracks, indicating formation of hard brittle structure therebetween, which easily dropped out during processing. Cracks were formed between the intermediate transition layer and the plating layer of comparative example 11, and the plating layer had lost adhesion.

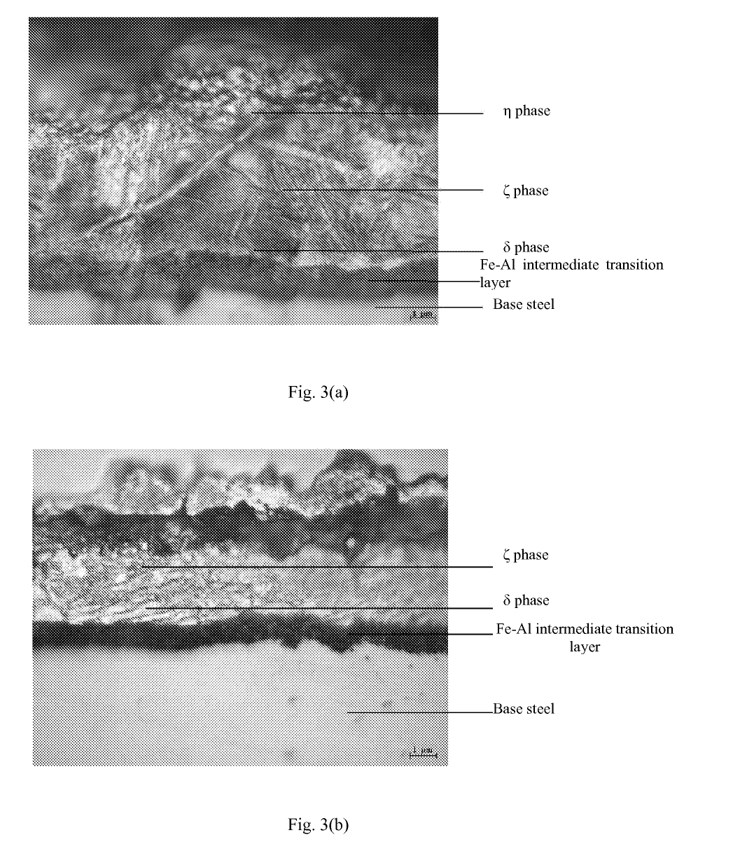

Metallurgical samples were ground and polished, etched in 2% nital etching solution and then metallographically photographed by a 100x high-performance optical metallographic microscope (model: OLYMPUS BX51). FIG. 3 shows metallographs of experimental examples and comparative examples. FIG. 3(a) can show the Fe-Al intermediate transition layer, thin δ phase and a little dispersed ξ phase in the plating layer which mostly consisted of η phase of a pure zinc layer. Adhesion testing of the plating layer showed that the plating layer of experimental example (1) had good adhesion. If Zn in the Fe-Al intermediate transition layer had supersaturated solubility and generated rich zinc solid solution, absolute content of Al in the intermediate transition layer did not reduce, but weight percentage of Al significantly reduced. Meanwhile, zinc supersaturation damaged homogeneity of the Fe-Al intermediate transition layer, thus the intermediate transition layer lost adhesive action and the effect of preventing diffusion, and formed thicker Fe-Zn alloy layer with more δ phase and ζ phase, simultaneously damaging adhesion of zinc layer. Although the metallograph of comparative example (6) shown in FIG. 3(b) also showed formation of the Fe-Al intermediate transition layer, percentage content of Al reduced and the number of Fe-Zn alloy layers increased, forming thicker δ phase and ξ phase; the pure zinc layer had thinner η phase, and adhesion of the plating layers was obviously poorer than that of experimental example 1.

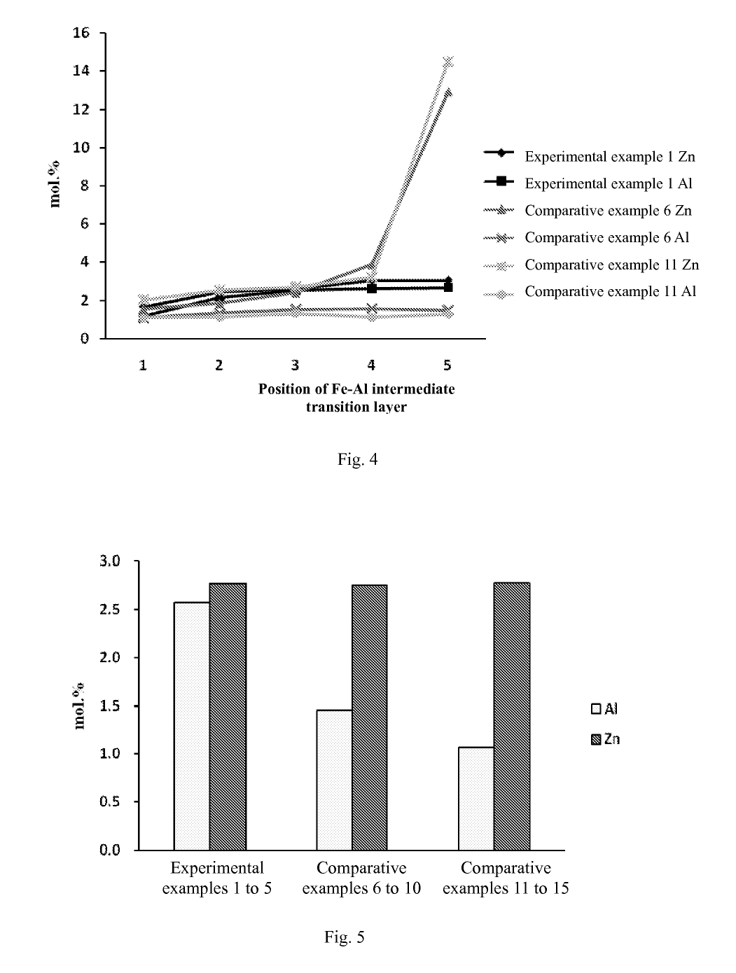

FIG. 4 shows schematic diagram of atomic percentage variations of the Al and Zn elements in the Fe-Al intermediate transition layers of the plating layers of experimental example 1 and comparative examples 6 and 11. FIG. 5 shows average atomic percentages of the Al and Zn elements at positions 2 to 4 in the Fe-Al intermediate transition layers of the plating layers of experimental example 1 and comparative examples 6 and 11. Table 2 lists atomic concentrations and Al/Zn ratios of Al and Zn in the Fe-Al intermediate transition layers of the plating layers of examples and comparative examples. The results showed that atomic percentages of Al in the Fe-Al intermediate transition layers of experimental examples were more than those of comparative examples, and atomic percentages of Zn of the experimental examples did not differ much from those of comparative examples, but Al/Zn ratios of experimental examples were more than 0.9 while Al/Zn ratios of comparative examples were 0.358-0.553.

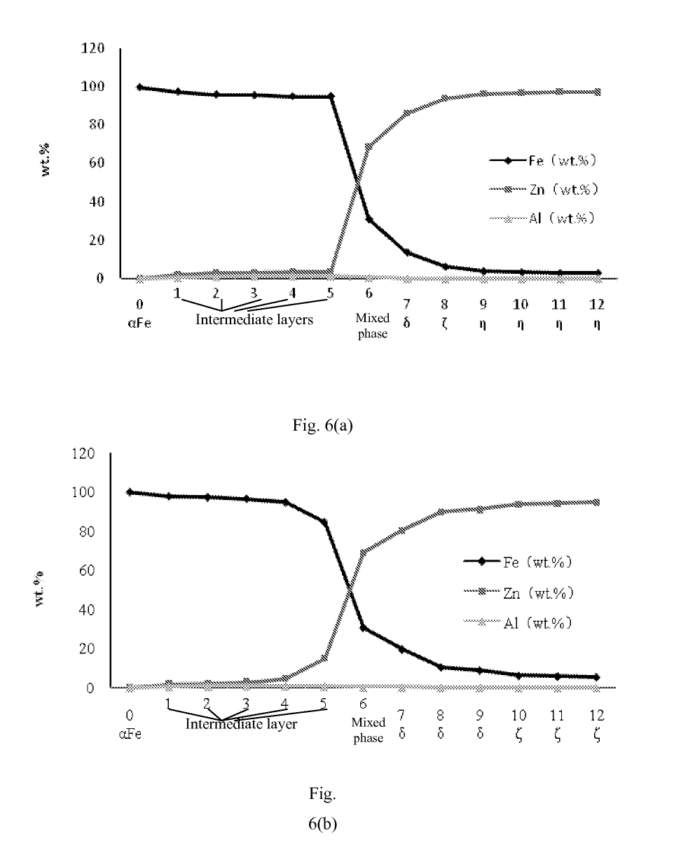

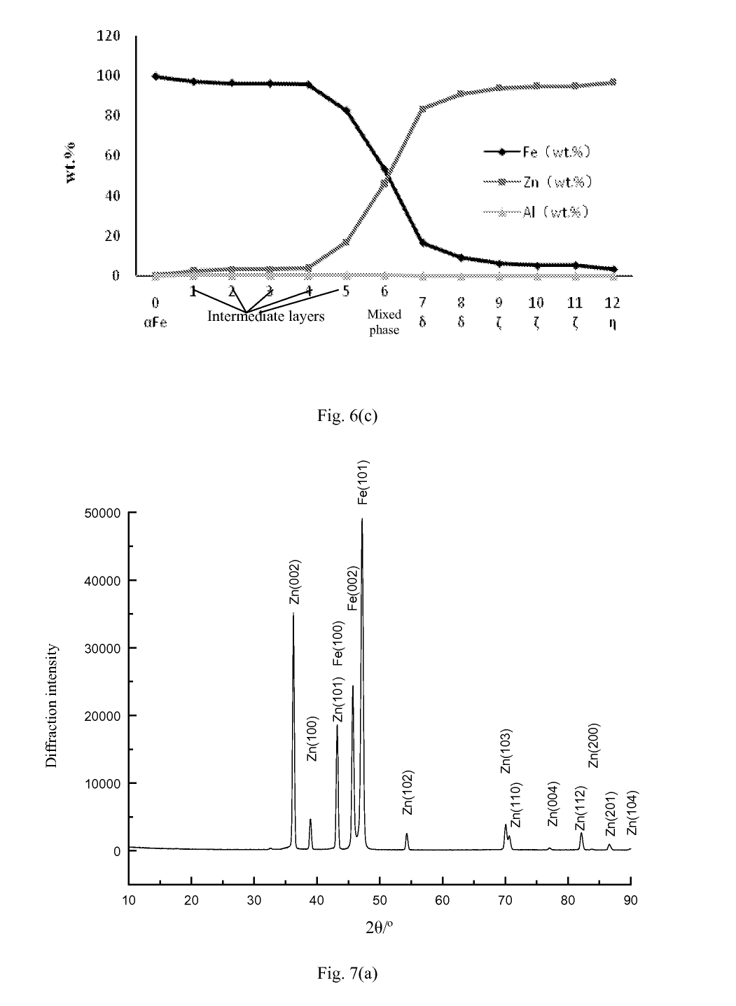

Mass percentages of elements of all phases in the plating structure were determined by EPM spectrum spot composition analysis. The δ phase, ζ phase and η phase can be judged to exist in the plating layers based on mass percentages of the Fe and Zn elements of all phases in the plating layers and metallographs of the plating structures. FIG. 6 shows mass percentage variations of the Fe, Zn and Al elements at various positions from base steel to the zinc layer surfaces in the plating layers of experimental example 1 (FIG. 6a), comparative example 6 (FIG. 6b) and comparative example 11 (FIG. 6c) and metallographic structures of the plating layers. Table 2 lists phase structures of various plating layers of experimental examples and comparative examples according to categories of phase structures measured at positions 7 to 12 of the zinc layers. The results showed that the plating layers had less δ phase and ξ phase and the pure zinc layers had more η phase in experimental examples, while the plating layers had thicker δ phase and ξ phase and the pure zinc layers had thinner η phase in comparative examples.

For hot-dip galvanized steel plates with good adhesion, when the Fe-Al intermediate transition layer with higher Al content was formed between base steel and the plating layers and only when Zn unsaturatedly dissolved and generated lean zinc solid solution in the Fe-Al intermediate transition layer, the layer can have adhesive action and the effect of preventing Fe-Zn diffusion, and formed thin Fe-Zn alloy layer with reduced δ phase and ζ phase, and δ phase and ξ phase reduced, under which the plating layer had good adhesion.

TABLE 2
Performance of the hot-dip galvanized steel plate

| | Fe—Al intermediate | | | | Grain orientation of |
|---|---|---|---|---|---|
| | transition layer | | | | zinc layer |
| | Al, | Zn, | Al/Zn | Phase | Intensity of Zn(002) |
| Test sample | mol % | mol % | ratio | structure | peak, cts |
| Experimental | 2.436 | 2.704 | 0.901 | 1δ, 1ξ, 4η | 35207 |
| example 1 | | | | | |
| Experimental | 2.578 | 2.803 | 0.920 | 1δ, 1ξ, 4η | 34891 |
| example 2 | | | | | |
| Experimental | 2.652 | 2.763 | 0.960 | 1δ, 2ξ, 3η | 34729 |
| example 3 | | | | | |
| Experimental | 2.449 | 2.676 | 0.915 | 1δ, 1ξ, 4η | 34672 |
| example 4 | | | | | |
| Experimental | 2.735 | 2.871 | 0.953 | 1δ, 2ξ, 3η | 35201 |
| example 5 | | | | | |
| Comparative | 1.484 | 2.684 | 0.553 | 3δ, 3ξ | 14679 |
| example 6 | | | | | |
| Comparative | 1.421 | 2.785 | 0.510 | 2δ, 3ξ, 1η | 15629 |
| example 7 | | | | | |
| Comparative | 1.382 | 2.739 | 0.505 | 3δ, 2ξ, 1η | 15372 |
| example 8 | | | | | |
| Comparative | 1.573 | 2.942 | 0.535 | 3δ, 2ξ, 1η | 16382 |
| example 9 | | | | | |
| Comparative | 1.392 | 2.576 | 0.540 | 2δ, 3ξ, 1η | 15890 |
| example 10 | | | | | |
| Comparative | 1.176 | 2.818 | 0.417 | 2δ, 3ξ, 1η | 16895 |
| example 11 | | | | | |
| Comparative | 1.083 | 2.731 | 0.397 | 2δ, 3ξ, 1η | 14903 |
| example 12 | | | | | |
| Comparative | 0.932 | 2.603 | 0.358 | 3δ, 3ξ | 15763 |
| example 13 | | | | | |
| Comparative | 1.117 | 2.902 | 0.385 | 3δ, 2ξ, 1η | 15394 |
| example 14 | | | | | |
| Comparative | 1.024 | 2.837 | 0.361 | 2δ, 3ξ, 1η | 16390 |
| example 15 | | | | | |

### (2) Grain Orientation of the Plating Layers

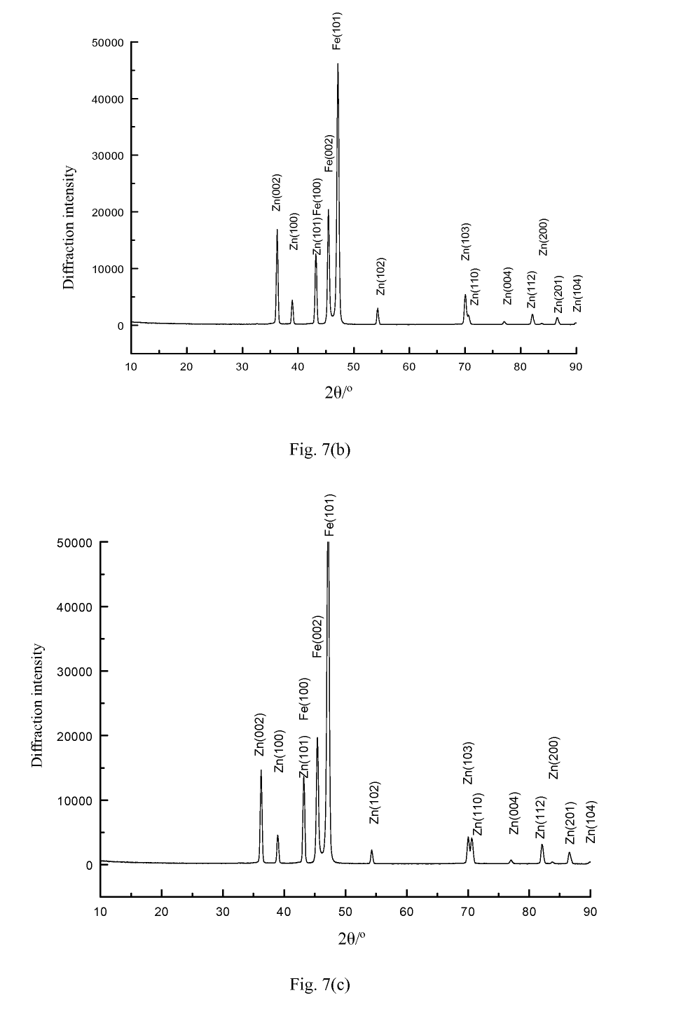

Surfaces of the plating layers were not treated, and small-angle diffraction (glancing angle: 5°) was respectively performed on the plating layers by an x-ray diffractometer (XRD) to determine diffraction peak intensity of the plating layers. FIG. 7 shows the typical diffraction patterns of the surfaces of the plating layers of experimental example 1 and comparative examples 6 and 11 at the glancing angle of 5°. Table 2 lists diffraction intensities of Zn(002) peaks of various samples. It can be seen that after temperature of the steel plate was increased to 475-485° while being sent to the plating bath, grains of the plating layers of experimental example samples 1 to 5 presented preferred orientation of Zn(002), and diffraction intensities of the Zn(002) peaks were significantly improved to be more than 34000 cts. However, diffraction intensities of the Zn(002) peaks were 14000-17000 cts in comparative examples 6 to 15 where temperature of the steel plate was not more than 465° while being sent to the plating bath.

### (3) Anti-Drop Performance of the Plating Layers

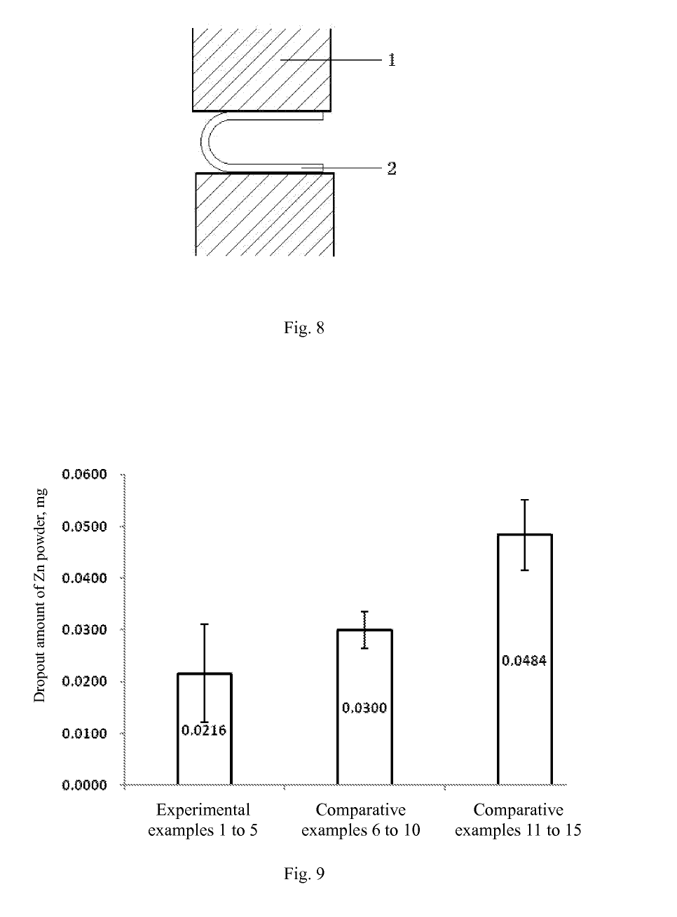

Anti-drop performance of the plating layers was tested by “U”-shape bend tests. The bend test was performed according to National Standard GB/T 232-1999 (Metallic Materials—Bend Test) and sample preparation referred to GB/T 2975-1998 (Steel and Steel Products-Location and Preparation of Test Pieces for Mechanical Testing). FIG. 8 shows final shape of bending samples. Samples were machined by a wire-cutting machine, sample surfaces were wiped by ethanol before tests, then insides and outsides of all bending parts of the samples were glued with scotch tapes with the same size, the samples and the adhesive tape were bent on a bending tester, the zinc powder dropped from the bending parts was collected by the adhesive tape and dropout amount of the zinc powder of various plating layers were measured by an ICP method. FIG. 9 shows dropout means and variances of zinc powder of samples of experimental examples and comparative examples. The dropout amount of zinc powder of experimental examples was obviously less than that of comparative examples. Table 3 lists evaluation on the anti-drop performance of the plating layers of various samples of examples and comparative examples according to the following standards: excellent (the dropout amount of zinc powder: ≦0.0100 mg); ∘ good (the dropout amount of zinc powder: 0.0100-0.0300 mg); slightly poor (the dropout amount of zinc powder: 0.0300-0.0360 mg); and ×poor (the dropout amount of zinc powder: ≧0.0440 mg).

### (4) Scratch Resistance of the Plating Layers

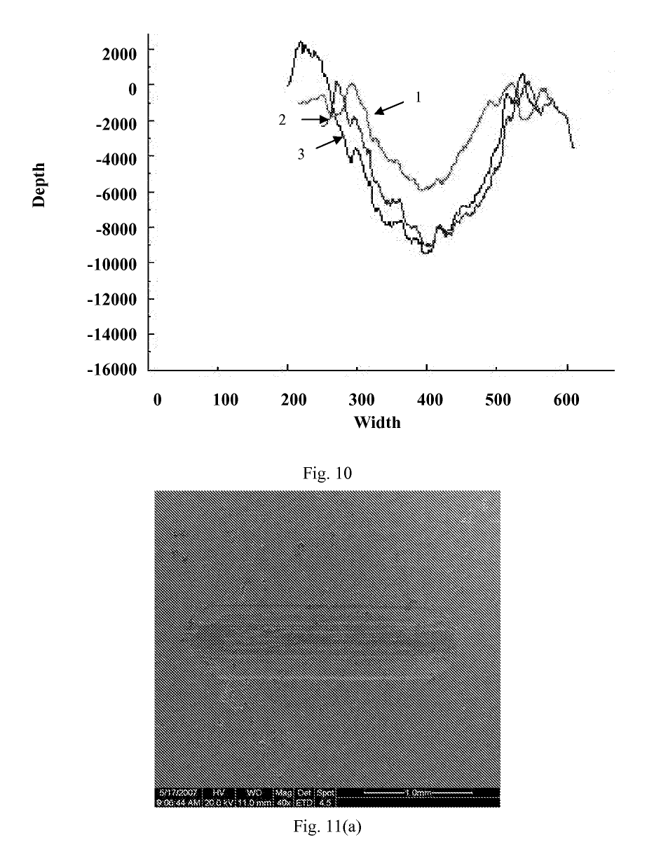

Scratch resistance tests of the plating layers were performed on a CETR UMT-2 multi-functional friction and wear tester from U.S., a scratch test device was adopted therein, and pressure head for the scratch tests contained shovel-shaped diamond with curvature radius of the head being 800 μm. A loading mode of linear increase was adopted and load was increased from 0.5 N to 2 N in the scratch tests. After tests, an Ambios XP2 profilometer was used to measure scratch profiles and morphologies of the various plating layers after the tests. FIG. 10 shows the typical profile survey results of middle scratch positions of the plating layers of experimental example 1 and comparative examples 6 and 11. It can be seen that scratch depth of the plating layer of experimental example 1 was obviously smaller than that of comparative examples 6 and 11. Table 3 lists evaluation on the scratch resistance of the plating layers of various samples of experimental examples and comparative examples according to the following standards: ∘ good (scratch depth: ≦7.00 μm); slightly poor (scratch depth: 7.00-8.00 μm); and × poor (scratch depth: ≧8.00 μm).

### (4) Wear Resistance of the Plating Layers

Wear resistance tests of the plating layers was performed on a reciprocating sliding friction test platform of a CETR UMT-2 multi-functional friction and wear tester from U.S.. Upper samples (ground samples) were stainless steel balls with diameter of 10 mm, and lower samples were the hot-dip galvanized steel plate. Reciprocating sliding friction and wear test parameters were as follows: normal load Fₙ=2 N, reciprocating displacement amplitude D=2 mm, relative movement speed V=2 mm/s, running time t=1000 s and cycle index N=500. After the test, an Ambios XP2 profilometer was adopted for measuring profiles and morphologies of wear marks of the various plating layers after the tests. FIG. 11 shows a general view of wear marks observed under SEM after reciprocating sliding wear test of experimental example 1 (FIG. 11a) and comparative example 6 (FIG. 11b) and comparative example 11 (FIG. 11c). It can be seen that experimental example 1 (FIG. 11a) had the least degree of wear; wear marks of comparative example 6 (FIG. 11b) had longer width; and wear marks of comparative example 11 (FIG. 11c) had the maximum width and most serious damage. Table 3 lists average friction coefficient of various samples of examples and comparative examples after 100 friction cycles and lists evaluation on the profiles of the wear marks according to the following standards: ∘ good (depth of wear marks: ≦8.00 μm); slightly poor (depth of wear marks: 8.00-10.00 μm); and × poor (depth of wear marks: ≧10.00 μm).

### (5) Overall Evaluation of Adhesion of the Plating Layers

Table 3 lists overall evaluation on adhesion of the plating layers of various samples of experimental examples and comparative examples according to the following standards: ∘ good (the number of good ∘ is more than 2 and the number of slightly poor is only 1); slightly poor (the number of good ∘ is 1 and the number of slightly poor is 2): and × poor (the number of poor × is more than 2 or the number of slightly poor is 2 and the number of poor × is 1).

TABLE 3
Performance evaluation of the hot-dip galvanized steel plate

| | Adhesion | | | | |
|---|---|---|---|---|---|
| | | | Friction | | |
| | | | Depth of wear | Friction | Overall |
| Test sample | Bend | Scratch | mark | coefficient | evaluation |
| Experimental | ◯ | ◯ | ◯ | 0.6549 | ◯ |
| example 1 | | | | | |
| Experimental | | ◯ | ◯ | 0.6677 | ◯ |
| example 2 | | | | | |
| Experimental | ◯ | ◯ | | 0.6534 | ◯ |
| example 3 | | | | | |
| Experimental | ◯ | ◯ | ◯ | 0.6451 | ◯ |
| example 4 | | | | | |
| Experimental | ◯ | ◯ | ◯ | 0.6495 | ◯ |
| example 5 | | | | | |
| Comparative | | X | | 0.6574 | X |
| example 6 | | | | | |
| Comparative | ◯ | | | 0.7006 | |
| example 7 | | | | | |
| Comparative | | | X | 0.6894 | X |
| example 8 | | | | | |
| Comparative | ◯ | X | X | 0.6928 | X |
| example 9 | | | | | |
| Comparative | | X | X | 0.7129 | X |
| example 10 | | | | | |
| Comparative | X | X | X | 0.6862 | X |
| example 11 | | | | | |
| Comparative | X | X | X | 0.6904 | X |
| example 12 | | | | | |
| Comparative | X | X | X | 0.7139 | X |
| example 13 | | | | | |
| Comparative | X | X | X | 0.7038 | X |
| example 14 | | | | | |
| Comparative | X | X | X | 0.7239 | X |
| example 15 | | | | | |

From evaluation results in Table 3, compared with previous steel plates (comparative examples 6 to 15), the hot-dip galvanized steel plate (experimental examples 1 to 5) obtained by increasing temperature of the steel plates at zinc pots to 475-485° and keeping other processes unchanged in the hot-dip galvanization process was characterized in that Al/Zn ratios of the Fe-Al intermediate transition layers of the plating layers were more than 0.9, δ phase and ξ phase of the plating layers reduced and η phase of the pure zinc layers increased; grains of the plating layers of experimental examples (samples 1 to 5) presented preferred orientation of Zn(002), and diffraction intensities of the Zn(002) peaks were significantly improved to be more than 34000 cts, thus significantly improving the anti-drop performance, scratch resistance and wear resistance of the plating layers, and obviously improving adhesion between the plating layers and the base steel.

In the experimental examples and comparative examples, it can be judged that the plating layers had good adhesion when the Al/Zn ratios were more than 0.9, the plating layers mainly had η phase, and adhesion of the plating layers was better when diffraction intensities of Zn(002) peaks thereof were more than 34000 cts by measuring atomic concentration ratios of Al and Zn in the Fe-Al intermediate transition layers, various phase structures of the plating layers and preferred grain orientation of the plating layers, and referring to adhesion evaluation of various plating layers.

### Example 2: Preparation and Performance Measurement of Experimental Examples 16 to 20 and Comparative Examples 21 to 25 of the Hot-Dip Galvanized Steel Plate

A DX1 cold-rolled steel plate which was 0.8 mm thick and contained 0.03-0.07% of C, 0.01-0.03% of Mn, 0.19-0.30% of Si, 0.006-0.019% of P, 0.009-0.020% of S, 0.02-0.07% of Al, Fe and inevitable impurities was pickled and annealed for hot-dip galvanization operation under hot-dip galvanization process conditions listed in Table 4. Initial temperature of the plating bath in a zinc pot was 450°, Fe content was less than 0.03% in the plating bath, speed of a unit is 100 m/min, high-span temperature of a cooling section was 240°, and cooling rate was 0%. Temperature of the steel plate was adjusted to 475° while being sent to the plating bath, and Al content of the plating bath was adjusted to more than 0.18% but not more than 0.21% for hot-dip galvanization operation to obtain experimental examples 16 to 20. Temperature of the steel plate was adjusted to 460° while being sent to plating bath, and Al content of the plating bath was adjusted to 0.16-0.17% for hot-dip galvanization operation to obtain comparative examples 21 to 25. Weight of a zinc layer was controlled to be about 180-195 g/m², and surface of the zinc layer was subject to SiO₂ passivation treatment.

TABLE 4
Hot-dip galvanization process conditions

| | | | | Hot-dip galvanization process conditions | | | |
|---|---|---|---|---|---|---|---|
| | | | | | Temperature | | High-span |
| | | | Weight | Speed | of steel plate | Al content | temperature |
| | Steel | Thickness, | of zinc | of unit, | while being sent | of plating | of cooling |
| Test sample | grade | mm | layer, g | m/min | to plating bath, ° | bath, % | section, ° |
| Experimental | DX51D | 0.80 | 185 | 100 | 475 | 0.20 | 240 |
| example 16 | | | | | | | |
| Experimental | DX51D | 0.80 | 185 | 100 | 475 | 0.19 | 240 |
| example 17 | | | | | | | |
| Experimental | DX51D | 0.80 | 185 | 100 | 475 | 0.21 | 240 |
| example 18 | | | | | | | |
| Experimental | DX51D | 0.80 | 185 | 100 | 475 | 0.19 | 240 |
| example 19 | | | | | | | |
| Experimental | DX51D | 0.80 | 185 | 100 | 475 | 0.20 | 240 |
| example 20 | | | | | | | |
| Comparative | DX51D | 0.80 | 183 | 100 | 460 | 0.165 | 240 |
| example 21 | | | | | | | |
| Comparative | DX51D | 0.80 | 183 | 100 | 460 | 0.168 | 240 |
| example 22 | | | | | | | |
| Comparative | DX51D | 0.80 | 183 | 100 | 460 | 0.170 | 240 |
| example 23 | | | | | | | |
| Comparative | DX51D | 0.80 | 183 | 100 | 460 | 0.162 | 240 |
| example 24 | | | | | | | |
| Comparative | DX51D | 0.80 | 183 | 100 | 460 | 0.165 | 240 |
| example 25 | | | | | | | |

### Performance Measurement of Experimental Examples 16 to 20 and Comparative Examples 21 to 25 of the Hot-Dip Galvanized Steel Plate

The following measuring methods and evaluation standards were the same as those of example 1.

### (1) Fe-Al Intermediate Transition Layer and Structures of Plating Layers

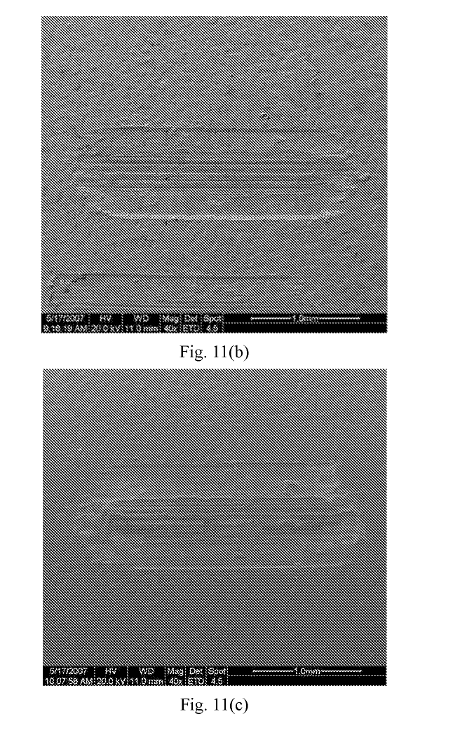

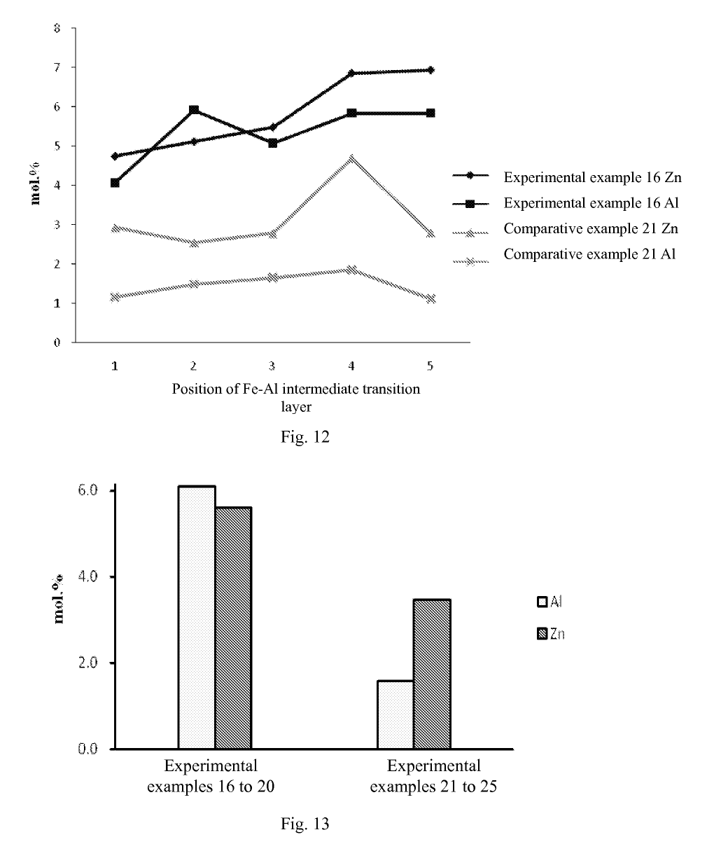

Spectrum surface scanning chromatograms of sections of the plating layers of experimental examples 16 to 20 by an electronic probe (model: EPMA1600) had the same results as experimental example 1 (refer to FIG. 1). FIG. 12 shows typical atomic percentage variations of Al and Zn elements of the Fe-Al intermediates layers in the plating layers of experimental examples 16 to 20 and comparative examples 21 to 25. FIG. 13 shows average atomic percentage variations of the Al and Zn elements at positions 2 to 4 of the Fe-Al intermediate transition layers in the plating layers of experimental examples 16 to 20 and comparative examples 21 to 25. Table 5 lists atomic concentrations and Al/Zn ratios of Al and Zn in the Fe-Al intermediate transition layers of various plating layers of experimental examples 16 to 20 and comparative examples 21 to 25. The results showed that atomic percentages of Al in the Fe-Al intermediate transition layers of the plating layers of experimental examples 16 to 20 were significantly more than those of comparative examples 21 to 25 while atomic percentages of Zn were more than those of various samples of comparative examples, but Al/Zn ratios of the Fe-Al intermediate transition layers of experimental examples 16 to 20 were 0.963-1.134 while Al/Zn ratios of the Fe-Al intermediate transition layers of comparative examples 21 to 25 were 0.421-0.499, the Al/Zn ratios of experimental examples 16 to 20 were significantly more than those of comparative examples 21 to 25 and the Al/Zn ratios of the Fe-Al intermediate transition layers of experimental examples 1 to 5.

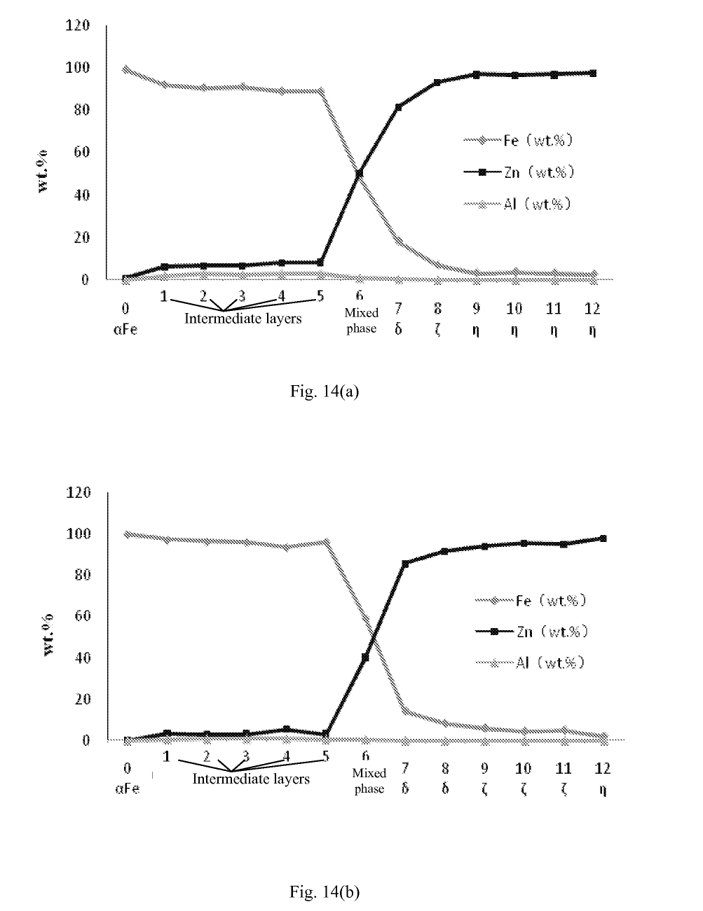

FIG. 14 shows mass percentage variations of the Fe, Zn and Al elements in the plating layers of experimental examples 16 to 20 and comparative example 21 and metallographic structures of the plating layers. Table 5 lists phase structures of various plating layers of experimental examples 16 to 20 and comparative examples 21 to 25. It can be seen that the plating layers had a little δ phase and ξ phase and the pure zinc layers had much η phase in experimental examples 16 to 20; while the plating layers had thicker δ phase and ξ phase and the pure zinc layers had thinner η phase in comparative examples.

TABLE 5
Performance of the hot-dip galvanized steel plate

| | | | | | Grain |
|---|---|---|---|---|---|
| | | | | | orientation of |
| | Fe—Al intermediate | | | | zinc layer |
| | transition layer | | | | Intensity of |
| | Al, | Zn, | Al/Zn | Phase | Zn(002) peak, |
| Test sample | mol % | mol % | ratio | structure | cts |
| Experimental | 5.608 | 5.822 | 0.963 | 1δ, 1ξ, 4η | 25271 |
| example 16 | | | | | |
| Experimental | 5.932 | 5.317 | 1.116 | 1δ, 1ξ, 4η | 24792 |
| example 17 | | | | | |
| Experimental | 5.843 | 5.152 | 1.134 | 1δ, 1ξ, 4η | 28937 |
| example 18 | | | | | |
| Experimental | 6.782 | 6.028 | 1.125 | 1δ, 1ξ, 4η | 27983 |
| example 19 | | | | | |
| Experimental | 6.369 | 5.675 | 1.122 | 1δ, 1ξ, 4η | 27381 |
| example 20 | | | | | |
| Comparative | 1.667 | 3.341 | 0.499 | 2δ, 3ξ, 1η | 14062 |
| example 21 | | | | | |
| Comparative | 1.639 | 3.492 | 0.469 | 2δ, 3ξ, 1η | 14870 |
| example 22 | | | | | |
| Comparative | 1.533 | 3.397 | 0.451 | 3δ, 3ξ | 14392 |
| example 23 | | | | | |
| Comparative | 1.492 | 3.543 | 0.421 | 2δ, 3ξ, 1η | 14029 |
| example 24 | | | | | |
| Comparative | 1.584 | 3.629 | 0.436 | 3δ, 2ξ, 1η | 14031 |
| example 25 | | | | | |

### (2) Grain Orientation of the Plating Layers

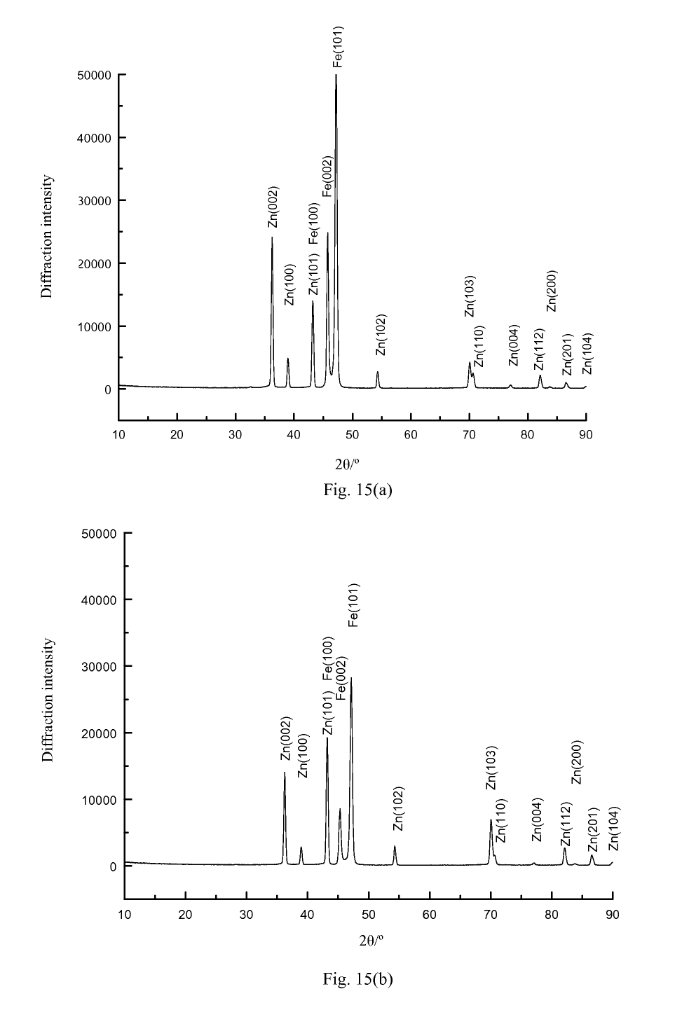

FIG. 15 shows typical diffraction patterns of the surfaces of the plating layers of experimental example 16 and comparative examples 21 at glancing angle of 5°. Table 5 lists diffraction intensities of Zn(002) peaks of various samples. It can be seen that after Al content of the plating bath in the hot-dip galvanization process was controlled to be more than 0.18% but not more than 0.21%, grains of the plating layers of experimental examples 16 to 20 also presented preferred orientation of Zn(002), and diffraction intensities of Zn(002) peaks were significantly improved to be more than 24000 cts. However, diffraction intensities of Zn(002) peaks were below 15000 cts in comparative examples 21 to 25 where Al content of the plating bath was controlled to be 0.16-0.17%.

### (3) Anti-Drop Performance of the Plating Layers

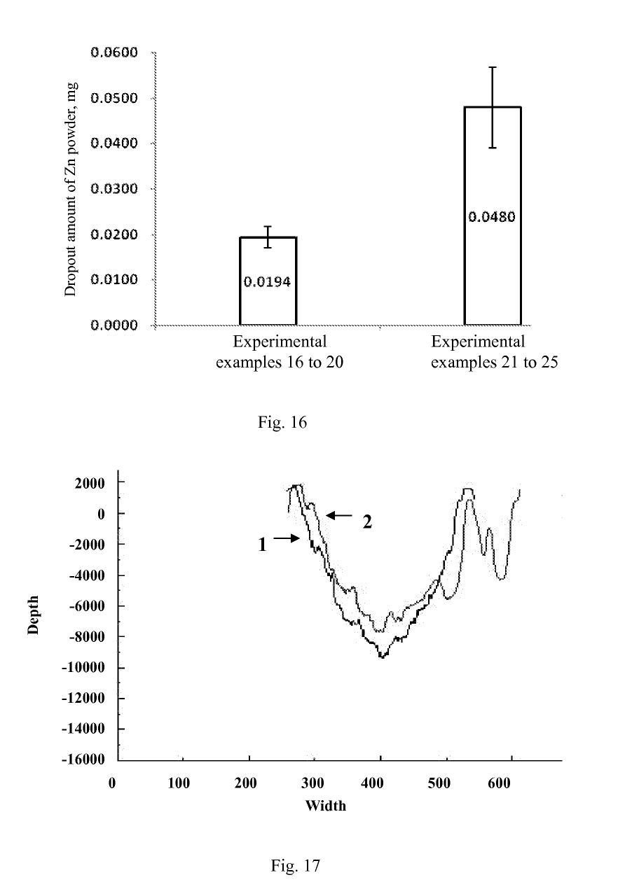

FIG. 16 shows dropout means and variances of zinc powder of experimental examples 16 to 20 and comparative examples 21 to 25. It can be seen that when Al content of the plating bath was more than 0.18% but not more than 0.21%, dropout amount of zinc powder of experimental examples 16 to 20 was obviously smaller than that of comparative examples 21 to 25 and experimental examples 1-6. Thus, improving temperature of strip steel while being sent to the plating bath and increasing Al content of the plating bath were more favorable to improving the anti-drop performance of the plating layers.

### (4) Scratch Resistance of the Plating Layers

FIG. 17 shows profile survey results of middle scratch positions of the plating layers of experimental example 16 and comparative example 21. It can be seen that when Al content of the plating bath was more than 0.18% but not more than 0.21%, scratch depth of the plating layer of experimental example 16 was obviously smaller than that of comparative example 21.

### (5) Wear Resistance of the Plating Layers

Table 6 lists average friction coefficients of various samples of experimental examples 16 to 20 and comparative examples 21 to 25 after 100 friction cycles.

### (6) Overall Evaluation of Adhesion of the Plating Layers

TABLE 6
Performance evaluation of the hot-dip galvanized steel plate

| | Adhesion | | | | |
|---|---|---|---|---|---|
| | | | Friction | | |
| | | | Depth of wear | Friction | Overall |
| Test sample | Bend | Scratch | marks | coefficient | evaluation |
| Experimental | ◯ | | ◯ | 0.7039 | ◯ |
| example 16 | | | | | |
| Experimental | ◯ | ◯ | ◯ | 0.6765 | ◯ |
| example 17 | | | | | |
| Experimental | ◯ | ◯ | ◯ | 0.6546 | ◯ |
| example 18 | | | | | |
| Experimental | ◯ | ◯ | ◯ | 0.6645 | ◯ |
| example 19 | | | | | |
| Experimental | ◯ | | ◯ | 0.6452 | ◯ |
| example 20 | | | | | |
| Comparative | X | X | X | 0.6811 | X |
| example 21 | | | | | |
| Comparative | X | X | X | 0.6938 | X |
| example 22 | | | | | |
| Comparative | X | X | X | 0.6967 | X |
| example 23 | | | | | |
| Comparative | X | X | X | 0.6893 | X |
| example 24 | | | | | |
| Comparative | X | X | X | 0.6843 | X |
| example 25 | | | | | |

From evaluation results in Table 6, compared with previous steel plates (comparative examples 21 to 25), the hot-dip galvanized steel plate (experimental examples 16 to 20) obtained by increasing temperature of strip steel while being sent to the plating bath to 475° and controlling Al content of the plating bath to be more than 0.18% but not more than 0.21%, but keeping other processes unchanged in the hot-dip galvanization process was characterized in that Al/Zn ratios of the Fe-Al intermediate transition layers of plating layers were 0.963-1.134 and more than those of experimental examples 1-6. δ phase and ξ phase of the plating layers obviously reduced, and η phase of the pure zinc layers increased and Zn(002) grains with preferred orientation were formed, thus significantly improving anti-drop performance, scratch resistance and wear resistance of the plating layers, and obviously improving adhesion between the plating layers and the base steel.

### Example 3: Preparation of Experimental Examples 21 to 30 and Comparative Examples 26 to 35 of the Hot-Dip Galvanized Steel Plate

A DX51D cold-rolled steel plate which was 0.8 mm thick and contained 0.03-0.07% of C, 0.01-0.03% of Mn, 0.19-0.30% of Si, 0.006-0.019% of P, 0.009-0.020% of S, 0.02-0.07% of Al, Fe and impurities was pickled and annealed for hot-dip galvanization operation under hot-dip galvanization process conditions listed in Table 7. Temperature of plating bath in a zinc pot was 450°, Fe content was less than 0.03% and Al content was 0.16-0.18% in the plating bath, temperature of the steel plate was 460° while being sent to the plating bath, and speed of a unit was 100 m/min. The steel plate was drawn from the zinc pot and then forcibly cooled by air cooling to obtain experimental examples 21 to 30 at the cooling rate of 70-90%, comparative examples 26 to 30 at the cooling rate of 30-50% and comparative examples 31 to 35 at the cooling rate of 0% (natural air cooling). Weight of a zinc layer was controlled to be about 180 g/m² and surface of the zinc layer was subject to SiO₂ passivation treatment. Grain orientation of the plating layers and adhesion of the plating layers such as anti-drop performance, scratch resistance and wear resistance were evaluated by the following method.

TABLE 7
Hot-dip galvanization process conditions

| | | | Hot-dip galvanization process conditions | | | |
|---|---|---|---|---|---|---|
| | | | | Temperature | | |
| | | Weight | Speed | of steel plate | Al content | |
| | Thickness, | of zinc | of unit, | while being sent | of plating | Fast |
| Test sample | mm | layer, g | m/min | to plating bath, ° | bath, % | cooling rate |
| Experimental | 0.80 | 186 | 110 | 460 | 0.170 | 90% |
| example 21 | | | | | | |
| Experimental | 0.80 | 186 | 110 | 460 | 0.171 | 90% |
| example 22 | | | | | | |
| Experimental | 0.80 | 186 | 110 | 460 | 0.170 | 90% |
| example 23 | | | | | | |
| Experimental | 0.80 | 186 | 120 | 460 | 0.172 | 80% |
| example 24 | | | | | | |
| Experimental | 0.80 | 186 | 120 | 460 | 0.171 | 90% |
| example 25 | | | | | | |
| Experimental | 0.80 | 184 | 110 | 460 | 0.170 | 70% |
| example 26 | | | | | | |
| Experimental | 0.80 | 184 | 110 | 460 | 0.171 | 70% |
| example 27 | | | | | | |
| Experimental | 0.80 | 184 | 110 | 460 | 0.170 | 80% |
| example 28 | | | | | | |
| Experimental | 0.80 | 184 | 120 | 460 | 0.172 | 70% |
| example 29 | | | | | | |
| Experimental | 0.80 | 184 | 120 | 460 | 0.170 | 70% |
| example 30 | | | | | | |
| Comparative | 0.80 | 183 | 110 | 460 | 0.170 | 40% |
| example 26 | | | | | | |
| Comparative | 0.80 | 183 | 110 | 460 | 0.171 | 40% |
| example 27 | | | | | | |
| Comparative | 0.80 | 183 | 110 | 460 | 0.170 | 30% |
| example 28 | | | | | | |
| Comparative | 0.80 | 184 | 120 | 460 | 0.170 | 40% |
| example 29 | | | | | | |
| Comparative | 0.80 | 184 | 120 | 460 | 0.171 | 30% |
| example 30 | | | | | | |
| Comparative | 0.80 | 183 | 110 | 460 | 0.170 | 0% |
| example 31 | | | | | | |
| Comparative | 0.80 | 183 | 110 | 460 | 0.171 | 0% |
| example 32 | | | | | | |
| Comparative | 0.80 | 183 | 110 | 460 | 0.170 | 0% |
| example 33 | | | | | | |
| Comparative | 0.80 | 183 | 120 | 460 | 0.171 | 0% |
| example 34 | | | | | | |
| Comparative | 0.80 | 183 | 120 | 460 | 0.170 | 0% |
| example 35 | | | | | | |

### Performance Measurement of Experimental Examples 21 to 30 and Comparative Examples 26 to 35 of the Hot-Dip Galvanized Steel Plate

The following measuring methods and evaluation standards were the same as those of example 1.

### (1) Grain Orientation of the Plating Layers

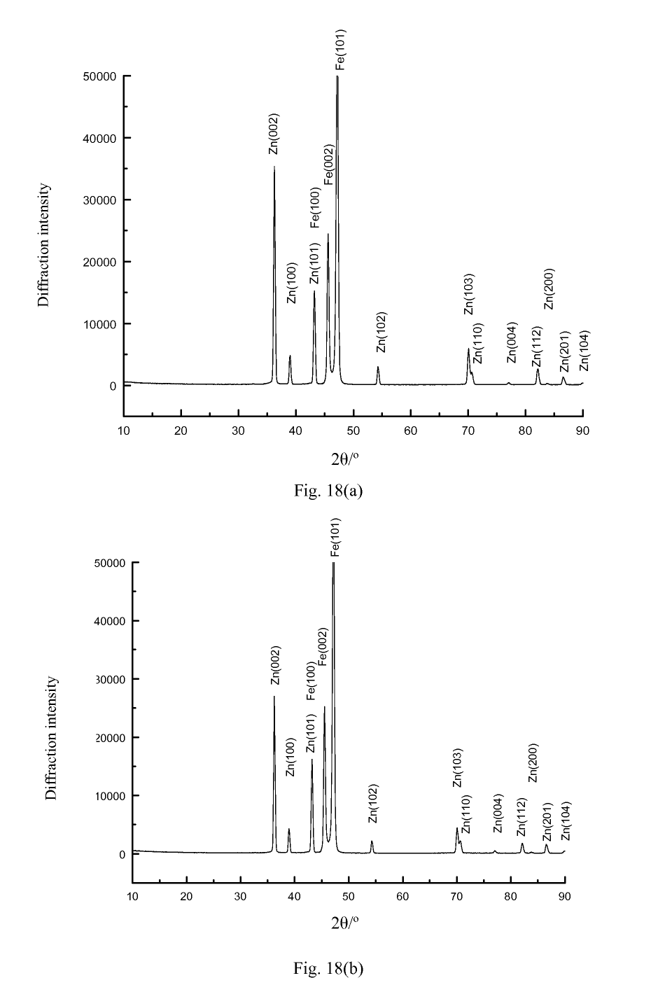

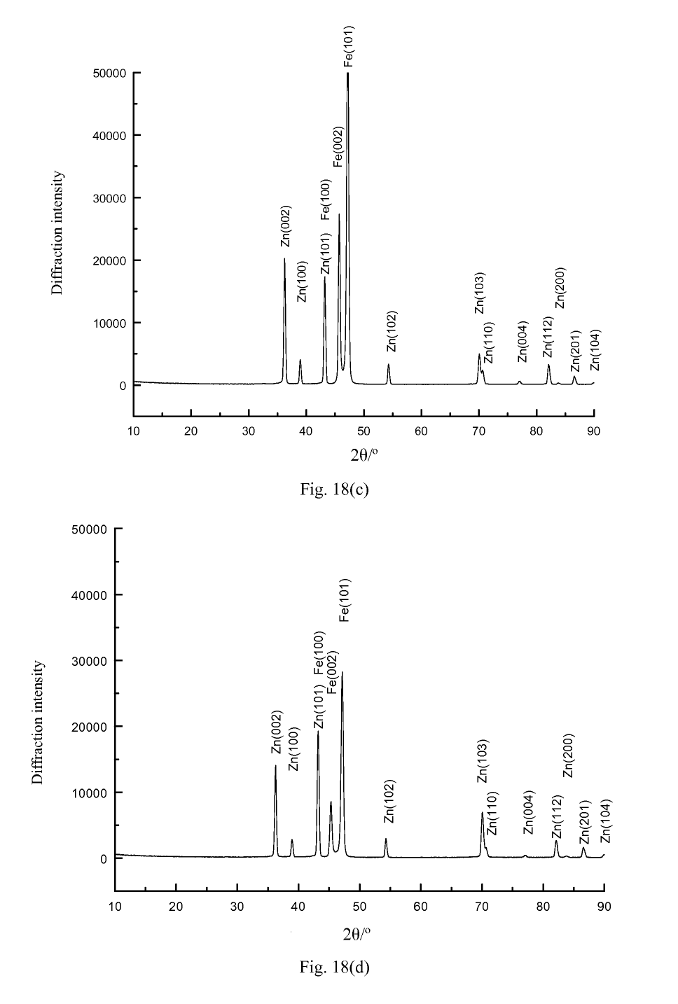

FIG. 18 shows typical diffraction patterns of the surfaces of the plating layers of experimental examples 21 and 26 and comparative examples 26 and 30 at glancing angle of 5°. It can be seen that intensity of the strongest diffraction peak Zn(002) of Zn in the plating layers of experimental examples 21 and 26 was far more than that of comparative examples 26 and 30, and maximum peaks of Zn were transferred from Zn(101) to Zn(002). Table 8 lists diffraction intensities of Zn(002) peaks of various samples and shows that diffraction intensities of Zn(002) peak are improved to be more than 27000 cts and grains of the plating layers presented preferred orientation of Zn(002) peaks when the cooling rate of experimental examples is increased to 70-90% compared with the cooling rate of comparative examples which is 30-50% and 0% respectively.

### (2) Anti-Drop Performance of the Plating Layers

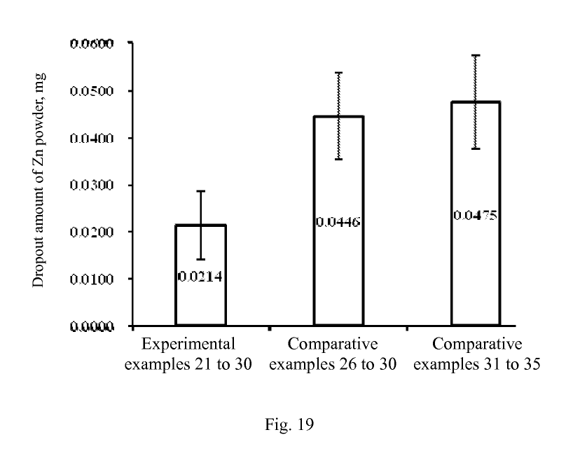

FIG. 19 shows dropout means and variances of zinc powder of samples of experimental examples and comparative examples. Dropout amount of zinc powder of experimental examples was obviously smaller than that of comparative examples.

### (3) Scratch Resistance of the Plating Layers

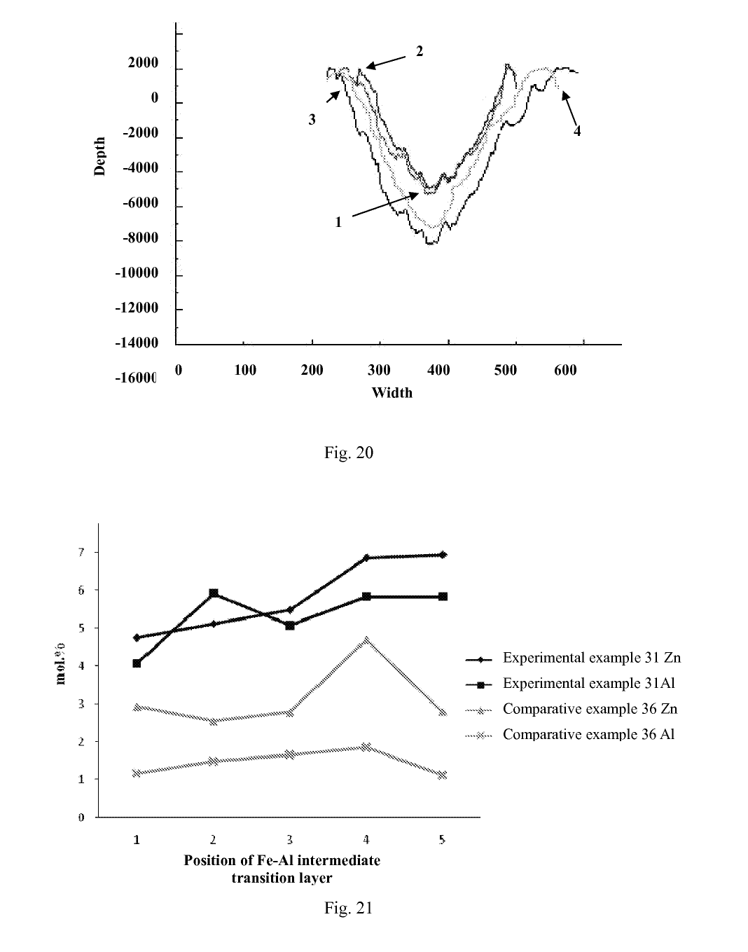

FIG. 20 shows typical profile survey results of middle scratch positions of the plating layers of experimental examples 21 and 26 and comparative examples 26 and 30, and shows that scratch depth of the plating layers of experimental examples is obviously smaller than that of comparative examples.

### (4) Wear Resistance of the Plating Layers

Table 8 lists average friction coefficients of various samples of experimental examples and comparative examples after 100 friction cycles.

### (5) Overall Evaluation of Adhesion of the Plating Layers

TABLE 8
Performance of the hot-dip galvanized steel plate

| | Grain | | | | | |
|---|---|---|---|---|---|---|
| | orientation of | Adhesion | | | | |
| | zinc layer | | | Friction | | |
| | Intensity of | | | Depth of | Friction | Overall |
| Test sample | Zn(002) peak, cts | Bend | Scratch | wear mark | coefficient | evaluation |
| Experimental | 35377 | ∘ | ∘ | ∘ | 0.6645 | ∘ |
| example 21 | | | | | | |
| Experimental | 34590 | | ∘ | ∘ | 0.6624 | ∘ |
| example 22 | | | | | | |
| Experimental | 35692 | ∘ | ∘ | ∘ | 0.6546 | ∘ |
| example 23 | | | | | | |
| Experimental | 34832 | ∘ | ∘ | ∘ | 0.6576 | ∘ |
| example 24 | | | | | | |
| Experimental | 34219 | | ∘ | ∘ | 0.6687 | ∘ |
| example 25 | | | | | | |
| Experimental | 27036 | ∘ | | | 0.6724 | |
| example 26 | | | | | | |
| Experimental | 28740 | ∘ | ∘ | ∘ | 0.6673 | ∘ |
| example 27 | | | | | | |
| Experimental | 29382 | ∘ | ∘ | ∘ | 0.6641 | ∘ |
| example 28 | | | | | | |
| Experimental | 33901 | ∘ | | ∘ | 0.6593 | ∘ |
| example 29 | | | | | | |
| Experimental | 28394 | ∘ | ∘ | | 0.6658 | ∘ |
| example 30 | | | | | | |
| Comparative | 20233 | x | x | | 0.6823 | x |
| example 26 | | | | | | |
| Comparative | 20192 | x | x | | 0.6874 | x |
| example 27 | | | | | | |
| Comparative | 19829 | | x | x | 0.6723 | x |
| example 28 | | | | | | |
| Comparative | 19328 | x | x | x | 0.6840 | x |
| example 29 | | | | | | |
| Comparative | 19320 | x | x | | 0.6842 | x |
| example 30 | | | | | | |
| Comparative | 14062 | x | x | x | 0.6811 | x |
| example 31 | | | | | | |
| Comparative | 14920 | x | x | x | 0.6877 | x |
| example 32 | | | | | | |
| Comparative | 14372 | x | x | x | 0.6927 | x |
| example 33 | | | | | | |
| Comparative | 14029 | x | x | x | 0.6893 | x |
| example 34 | | | | | | |
| Comparative | 14031 | x | x | x | 0.6843 | x |
| example 35 | | | | | | |

From evaluation results in Table 8, compared with previous steel plates (comparative examples), the hot-dip galvanized steel plate (experimental examples) obtained by increasing cooling rate of the steel plate to 70-90%, but keeping other processes unchanged in the hot-dip galvanization process is characterized in that grains of the plating layers presented preferred orientation of Zn(002), thus significantly improving anti-drop performance, scratch resistance and wear resistance of the plating layers, and obviously improving adhesion between the plating layers and the base steel.

### Example 4: Preparation of Experimental Examples 31 to 35 and Comparative Examples 36 to 40 of the Hot-Dip Galvanized Steel Plate

A DX1 cold-rolled steel plate which was 0.8 mm thick and contained 0.03-0.07% of C, 0.01-0.03% of Mn, 0.19-0.30% of Si, 0.006-0.019% of P, 0.009-0.020% of S, 0.02-0.07% of Al, Fe and inevitable impurities was pickled and annealed for hot-dip galvanization operation under hot-dip galvanization process conditions listed in Table 9. Initial temperature of plating bath in a zinc pot was 450°, Fe content was less than 0.03% in the plating bath, temperature of the steel plate was 460° while being sent to the plating bath, speed of a unit was 100 m/min, high-span temperature of a cooling section was 240°, and cooling rate was 0%. Al content of the plating bath wais adjusted to 0.21-0.25% for hot-dip galvanization operation to obtain experimental examples 31 to 35; and Al content of the plating bath was adjusted to 0.16-0.18% for hot-dip galvanization operation to obtain comparative examples 36 to 40. Weight of a zinc layer was controlled to be about 180-195 g/m² and surface of the zinc layer was subject to SiO₂ passivation treatment.

TABLE 9
Hot-dip galvanization process conditions

| | | | | Hot-dip galvanization process conditions | | | |
|---|---|---|---|---|---|---|---|
| | | | | | Temperature | | High-span |
| | | | Weight | Speed | of steel plate | Al content | temperature |
| | Steel | Thickness, | of zinc | of unit, | while being sent | of plating | of cooling |
| Test sample | grade | mm | layer, g | m/min | to plating bath, ° | bath, % | section, ° |
| Experimental | DX51D | 0.80 | 187 | 100 | 460 | 0.22 | 240 |
| example 31 | | | | | | | |
| Experimental | DX51D | 0.80 | 187 | 100 | 460 | 0.23 | 240 |
| example 32 | | | | | | | |
| Experimental | DX51D | 0.80 | 187 | 100 | 460 | 0.21 | 240 |
| example 33 | | | | | | | |
| Experimental | DX51D | 0.80 | 187 | 100 | 460 | 0.23 | 240 |
| example 34 | | | | | | | |
| Experimental | DX51D | 0.80 | 187 | 100 | 460 | 0.22 | 240 |
| example 35 | | | | | | | |
| Comparative | DX51D | 0.80 | 183 | 100 | 460 | 0.170 | 240 |
| example 36 | | | | | | | |
| Comparative | DX51D | 0.80 | 183 | 100 | 460 | 0.168 | 240 |
| example 37 | | | | | | | |
| Comparative | DX51D | 0.80 | 183 | 100 | 460 | 0.171 | 240 |
| example 38 | | | | | | | |
| Comparative | DX51D | 0.80 | 183 | 100 | 460 | 0.169 | 240 |
| example 39 | | | | | | | |
| Comparative | DX51D | 0.80 | 183 | 100 | 460 | 0.170 | 240 |
| example 40 | | | | | | | |

### Performance Measurement of Experimental Examples 31 to 35 and Comparative Examples 36 to 40 of the Hot-Dip Galvanized Steel Plate

The following measuring methods and evaluation standards were the same as those of example 1.

### (1) Fe-Al Intermediate Transition Layers and Structures of Plating Layers

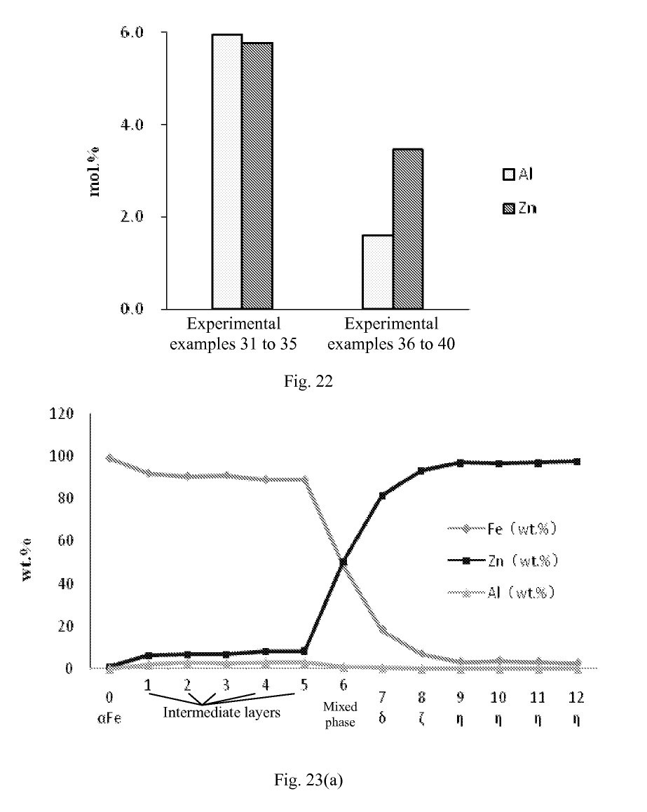

Typical spectrum surface scanning chromatograms of sections of the plating layers of experimental example 31 by an electronic probe (model: EPMA1600) had the same results as experimental example 1 (refer to FIG. 1). FIG. 21 shows atomic percentage variations of Al and Zn elements in the Fe-Al intermediate transition layers of the plating layers of typical experimental example sample 31 and comparative example sample 36. FIG. 22 shows average atomic percentages of the Al and Zn elements at positions 2 to 4 of the Fe-Al intermediate transition layers of the plating layers of experimental example samples 31 to 35 and comparative example samples 36 to 40. Table 10 lists atomic concentrations and Al/Zn ratios of the Fe-Al intermediate transition layers of various plating layers of experimental examples and comparative examples. The results showed that atomic percentages of Al in the Fe-Al intermediate transition layers of experimental examples were significantly more than those of comparative examples, and atomic percentages of Zn of experimental examples were more than those of comparative examples, but Al/Zn ratios of experimental examples were 0.940-1.125 while Al/Zn ratios of comparative examples were 0.421-0.499, thus the Al/Zn ratios of experimental examples were significantly more than those of comparative examples.

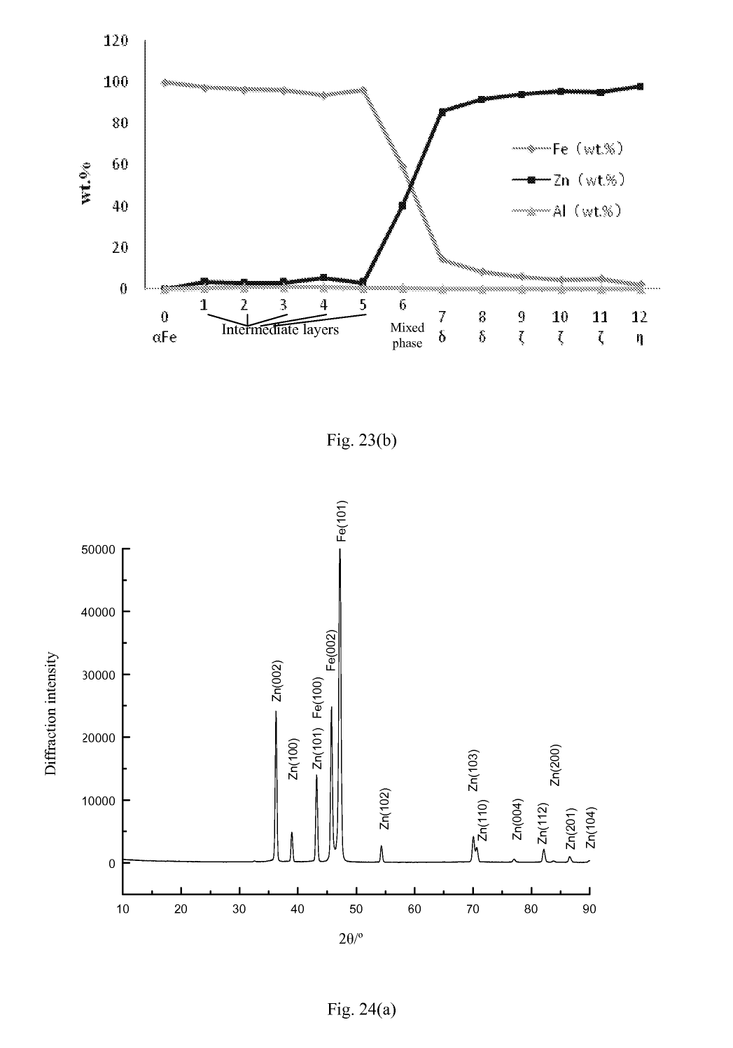

FIG. 23 shows mass percentage variations of the Fe, Zn and Al elements in the plating layers of experimental example 31 and comparative example 36 and metallographic structures of the plating layers. Table 10 lists phase structures of various plating layers of experimental examples and comparative examples. The results showed that the plating layers had less δ phase and ξ phase and the pure zinc layers had more η phase in experimental examples while the plating layers had thicker δ phase and ξ phase and the pure zinc layers had thinner η phase in comparative examples.

TABLE 10
Performance of the hot-dip galvanized steel plate

| | | | | | Grain |
|---|---|---|---|---|---|
| | | | | | orientation of |
| | Fe—Al intermediate | | | | zinc layer |
| | transition layer | | | | Intensity of |
| | Al, | Zn, | Al/Zn | Phase | Zn(002) peak, |
| Test sample | mol % | mol % | ratio | structure | cts |
| Experimental | 5.608 | 5.822 | 0.963 | 1δ, 1ξ, 4η | 24139 |
| example 31 | | | | | |
| Experimental | 5.932 | 5.429 | 1.093 | 1δ, 2ξ, 3η | 25738 |
| example 32 | | | | | |
| Experimental | 5.023 | 5.342 | 0.940 | 1δ, 1ξ, 4η | 28372 |
| example 33 | | | | | |
| Experimental | 6.782 | 6.028 | 1.125 | 1δ, 1ξ, 4η | 27381 |
| example 34 | | | | | |
| Experimental | 6.369 | 6.183 | 1.030 | 1δ, 2ξ, 3η | 25679 |
| example 35 | | | | | |
| Comparative | 1.667 | 3.341 | 0.499 | 2δ, 3ξ, 1η | 14062 |
| example 36 | | | | | |
| Comparative | 1.639 | 3.492 | 0.469 | 2δ, 3ξ, 1η | 14870 |
| example 37 | | | | | |
| Comparative | 1.533 | 3.397 | 0.451 | 3δ, 3ξ | 14392 |
| example 38 | | | | | |
| Comparative | 1.492 | 3.543 | 0.421 | 2δ, 3ξ, 1η | 14029 |
| example 39 | | | | | |
| Comparative | 1.584 | 3.629 | 0.436 | 3δ, 2ξ, 1η | 14031 |
| example 40 | | | | | |

### (2) Grain Orientation of the Plating Layers

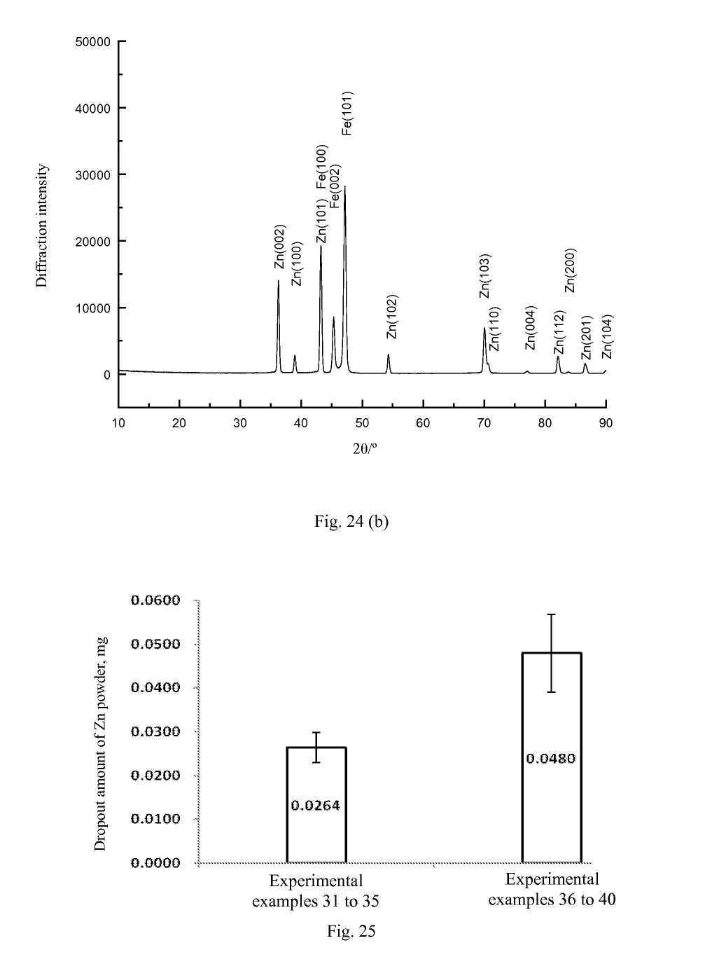

FIG. 24 shows typical diffraction patterns of the surfaces of the plating layers of experimental example 31 and comparative example 36 at glancing angle of 5°. Table 10 lists diffraction intensities of Zn(002) peaks of various samples. It can be seen that after Al content of the plating bath in the hot-dip galvanization process was controlled to be 0.21-0.25%, grains of the plating layers of experimental examples 31 to 35 presented preferred orientation of Zn(002), and diffraction intensities of Zn(002) peaks were significantly improved to be more than 24000 cts. However, diffraction intensities of the Zn(002) peaks were below 15000 cts in comparative examples 36 to 40 where Al content of the plating bath was controlled to be 0.16-0.18%.

### (3) Anti-drop Performance of the Plating Layer

FIG. 25 shows dropout means and variances of zinc powder of experimental examples 31 to 35 and comparative examples 36 to 40. It can be seen that when Al content of the plating bath was 0.21-0.25%, dropout amount of zinc powder of experimental examples 31 to 35 was obviously smaller than that of comparative examples 36 to 40.

### (4) Scratch Resistance of the Plating Layers

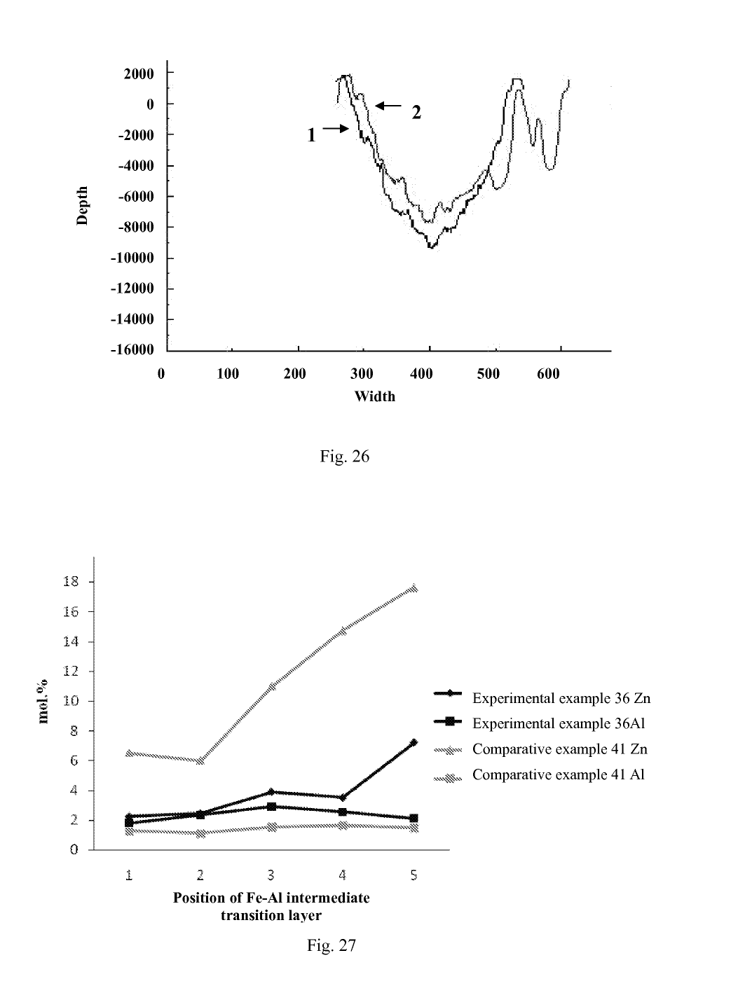

FIG. 26 shows profile survey results of middle scratch positions of the plating layers of experimental example 31 and comparative example 36. It can be seen that when Al content of the plating bath was 0.21-0.25%, scratch depth of the plating layers of experimental examples was obviously smaller than that of comparative examples.

### (5) Wear Resistance of the Plating Layers

Table 11 lists average friction coefficients of various samples of examples and comparative examples after 100 friction cycles.

### (6) Overall Evaluation of Adhesion of the Plating Layers

TABLE 11
Performance evaluation of the hot-dip galvanized steel plate

| | Adhesion | | | | |
|---|---|---|---|---|---|
| | | | Friction | | Overall |
| | | | Depth of | Friction | evaluation of |
| Test sample | Bend | Scratch | wear mark | coefficient | adhesion |
| Experimental | ◯ | | ◯ | 0.7702 | ◯ |
| example 31 | | | | | |
| Experimental | ◯ | ◯ | ◯ | 0.6856 | ◯ |
| example 32 | | | | | |
| Experimental | ◯ | ◯ | ◯ | 0.6832 | ◯ |
| example 33 | | | | | |
| Experimental | ◯ | ◯ | ◯ | 0.6753 | ◯ |
| example 34 | | | | | |
| Experimental | ◯ | | ◯ | 0.6638 | ◯ |
| example 35 | | | | | |
| Comparative | X | X | X | 0.6811 | X |
| example 36 | | | | | |
| Comparative | X | X | X | 0.6938 | X |
| example 37 | | | | | |
| Comparative | X | X | X | 0.6967 | X |
| example 38 | | | | | |
| Comparative | X | X | X | 0.6893 | X |
| example 39 | | | | | |
| Comparative | X | X | X | 0.6843 | X |
| example 40 | | | | | |

From evaluation results in Table 11, compared with previous steel plates (comparative examples), the hot-dip galvanized steel plate (experimental examples) obtained by controlling Al content of the plating bath to be 0.21-0.25%, but keeping other processes unchanged in the hot-dip galvanization process was characterized in that Al/Zn ratios of the Fe-Al intermediate transition layers of the plating layers were 0.940-1.125, δ phase and ξ phase of the plating layers obviously reduced, and η phase of the pure zinc layers increased and Zn(002) grains with preferred orientation were formed, thus significantly improving anti-drop performance, scratch resistance and wear resistance of the plating layers, and obviously improving adhesion between the plating layers and the base steel.

### Example 5: Preparation of Experimental Examples 36 to 42 and Comparative Examples 41 to 47 of the Hot-Dip Galvanized Steel Plate

A DX1 cold-rolled steel plate which was 0.8 mm thick and contained 0.03-0.07% of C, 0.01-0.03% of Mn, 0.19-0.30% of Si, 0.006-0.019% of P, 0.009-0.020% of S, 0.02-0.07% of Al, Fe and impurities was pickled and annealed for hot-dip galvanization operation under hot-dip galvanization process conditions listed in Table 12. Temperature of plating bath in a zinc pot was 450°, Fe content was less than 0.03% and Al content was 0.16-0.18% in the plating bath, temperature of the steel plate was 460° while being sent to plating bath, speed of a unit is 100 m/min, cooling rate was 0%, and high-span temperature of a cooling section was adjusted to 210-220° to obtain experimental examples 36 to 42; and the high-span temperature of the cooling section was adjusted to 240-260° to obtain comparative examples 41 to 47. Weight of a zinc layer was controlled to be about 180-195 g/m² and surface of the zinc layer was subject to SiO₂ passivation treatment.

TABLE 12
Hot-dip galvanization process conditions

| | | | Hot-dip galvanization process conditions | | | |
|---|---|---|---|---|---|---|
| | | | | Temperature | | High-span |
| | | | | of steel plate | Al content | temperature |
| | Thickness | Weight of | Speed of | while being sent | of plating | of a cooling |
| Test sample | mm | zinc layer, g | unit, m/min | to plating bath, ° | bath, % | section, ° |
| Experimental | 0.80 | 182 | 100 | 460 | 0.170 | 210 |
| example 36 | | | | | | |
| Experimental | 0.80 | 182 | 100 | 460 | 0.171 | 220 |
| example 37 | | | | | | |
| Experimental | 0.80 | 182 | 100 | 460 | 0.170 | 210 |
| example 38 | | | | | | |
| Experimental | 0.80 | 182 | 100 | 460 | 0.171 | 220 |
| example 39 | | | | | | |
| Experimental | 0.80 | 182 | 100 | 460 | 0.170 | 220 |
| example 40 | | | | | | |
| Experimental | 0.80 | 182 | 100 | 460 | 0.171 | 210 |
| example 41 | | | | | | |
| Experimental | 0.80 | 182 | 100 | 460 | 0.170 | 210 |
| example 42 | | | | | | |
| Comparative | 0.80 | 182 | 100 | 460 | 0.170 | 260 |
| example 41 | | | | | | |
| Comparative | 0.80 | 182 | 100 | 460 | 0.171 | 250 |
| example 42 | | | | | | |
| Comparative | 0.80 | 182 | 100 | 460 | 0.170 | 250 |
| example 43 | | | | | | |
| Comparative | 0.80 | 182 | 100 | 460 | 0.171 | 260 |
| example 44 | | | | | | |
| Comparative | 0.80 | 182 | 100 | 460 | 0.172 | 260 |
| example 45 | | | | | | |
| Comparative | 0.80 | 182 | 100 | 460 | 0.170 | 250 |
| example 46 | | | | | | |
| Comparative | 0.80 | 182 | 100 | 460 | 0.171 | 260 |
| example 47 | | | | | | |

### Performance Measurement of Experimental Examples 36 to 42 and Comparative Examples 41 to 47 of the Hot-Dip Galvanized Steel Plate

### (1) Fe-Al Intermediate Transition Layers and Structures of Plating Layers

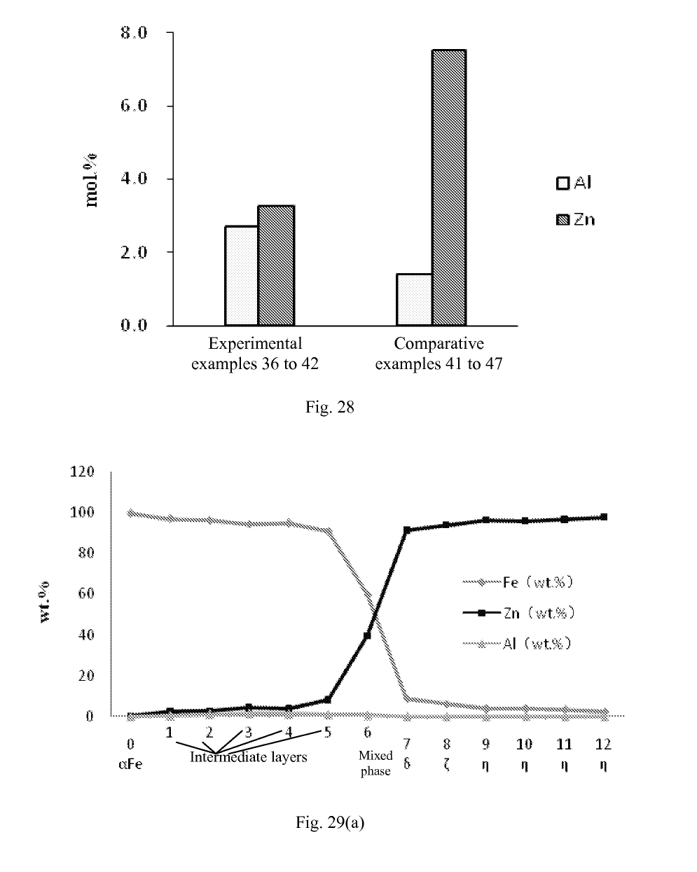

Typical spectrum surface scanning chromatograms of sections of the plating layers of experimental example 36 by an electronic probe (model: EPMA1600) had the same results as experimental example 1 (refer to FIG. 1). FIG. 27 shows atomic percentage variations of Al and Zn elements in the Fe-Al intermediate transition layers of the plating layers of typical experimental example 36 and comparative example 41. FIG. 28 shows average atomic percentages of the Al and Zn elements at positions 2 to 4 of the Fe-Al intermediate transition layers of plating layers of experimental examples 36 to 42 and comparative examples 41 to 47. Table 13 lists atomic concentrations and Al/Zn ratios of the Fe-Al intermediate transition layers of various plating layers of experimental examples and comparative examples. The results showed that atomic percentages of Al of the Fe-Al intermediate transition layers of experimental examples were more than those of comparative examples, atomic percentages of Zn were less than those of comparative examples, and Al/Zn ratios of experimental examples were 0.757-0.884 while Al/Zn ratios of comparative examples were 0.131-0.535, thus the Al/Zn ratios of experimental examples were significantly more than those of comparative examples.

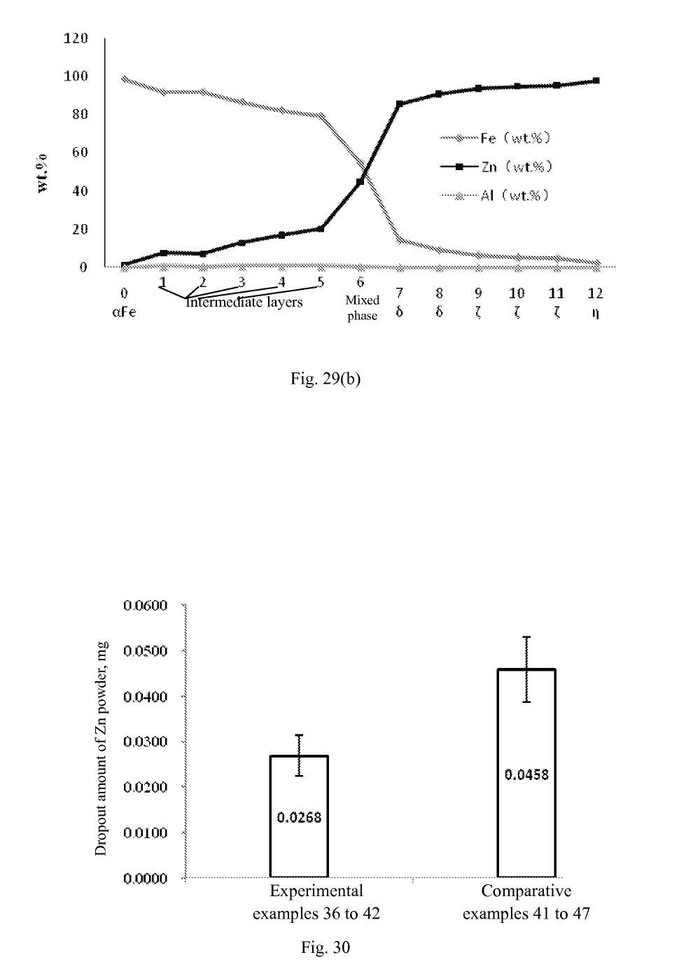

FIG. 29 shows mass percentage variations of the Fe, Zn and Al elements in the plating layers of experimental example 36 and comparative example 41 and metallographic structures of the plating layers. Table 13 lists phase structures of various plating layers of experimental examples and comparative examples. It can be seen that the plating layers had less δ phase and ξ phase and the pure zinc layers had more η phase in experimental examples while the plating layers had thicker δ phase and ξ phase and the pure zinc layers had thinner η phase in comparative examples.

### (2) Anti-Drop Performance of the Plating Layer

FIG. 30 shows dropout means and variances of zinc powder of experimental examples 36 to 42 and comparative examples 41 to 47. It can be seen that dropout amount of zinc powder of experimental examples 36 to 42 was obviously smaller than that of comparative examples 41 to 47.

### (3) Scratch Resistance of the Plating Layers

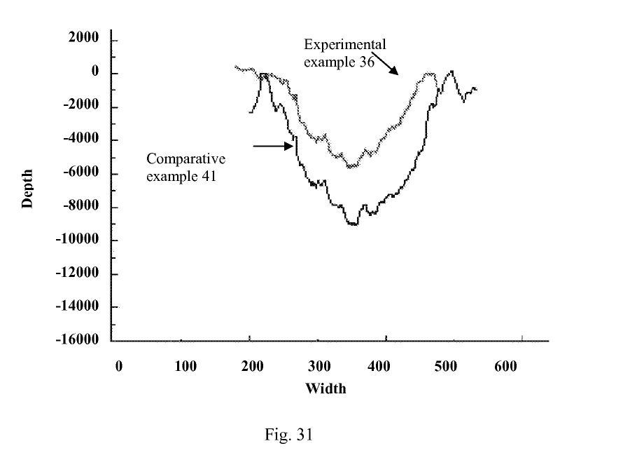

FIG. 31 shows profile survey results at middle scratch positions of experimental example 36 and comparative example 41. It can be seen that when high-span temperature of a cooling section was adjusted to 210-220°, scratch depth of the plating layers of experimental examples was obviously smaller than that of comparative examples.

### (4) Wear Resistance of the Plating Layers

Table 13 lists average friction coefficient of various samples of experimental examples and comparative examples after 100 friction cycles.

### (5) Overall Evaluation of Adhesion of the Plating Layers

TABLE 13
Performance of the hot-dip galvanized steel plate

| | Fe—Al intermediate | | | | Adhesion | | | | |
|---|---|---|---|---|---|---|---|---|---|
| | transition layer | | | | | | Friction | | |
| | Al, | Zn, | Al/Zn | Phase | | | Depth of | Friction | Overall |
| Test sample | mol % | mol % | ratio | structure | Bend | Scratch | wear mark | coefficient | evaluation |
| Experimental | 2.590 | 3.277 | 0.790 | 1δ, 1ξ, | ∘ | ∘ | ∘ | 0.6456 | ∘ |
| example 36 | | | | 4η | | | | | |
| Experimental | 2.734 | 3.318 | 0.824 | 1δ, 2ξ, | ∘ | ∘ | ∘ | 0.6547 | ∘ |
| example 37 | | | | 3η | | | | | |
| Experimental | 2.728 | 3.420 | 0.798 | 1δ, 1ξ, | ∘ | | ∘ | 0.6453 | ∘ |
| example 38 | | | | 4η, | | | | | |
| Experimental | 2.602 | 3.233 | 0.805 | 1δ, 2ξ, | ∘ | ∘ | | 0.6538 | ∘ |
| example 39 | | | | 3η | | | | | |
| Experimental | 2.829 | 3.201 | 0.884 | 1δ, 2ξ, | | ∘ | ∘ | 0.6439 | ∘ |
| example 40 | | | | 3η | | | | | |
| Experimental | 2.568 | 3.394 | 0.757 | 1δ, 1ξ, | ∘ | ∘ | | 0.6502 | ∘ |
| example 41 | | | | 4η, | | | | | |
| Experimental | 2.734 | 3.213 | 0.851 | 1δ, 1ξ, | ∘ | ∘ | ∘ | 0.6610 | ∘ |
| example 42 | | | | 4η, | | | | | |
| Comparative | 1.432 | 10.574 | 0.135 | 2δ, 3ξ, | x | x | x | 0.6974 | x |
| example 41 | | | | 1η | | | | | |
| Comparative | 1.293 | 7.820 | 0.165 | 3δ, 2ξ, | | x | x | 0.7039 | x |
| example 42 | | | | 1η | | | | | |
| Comparative | 1.482 | 8.932 | 0.166 | 2δ, 4ξ | x | x | | 0.7125 | x |
| example 43 | | | | | | | | | |
| Comparative | 1.297 | 9.203 | 0.141 | 2δ, 3ξ, | x | x | x | 0.7039 | x |
| example 44 | | | | 1η | | | | | |
| Comparative | 1.378 | 10.498 | 0.131 | 3δ, 2ξ, | | x | x | 0.7227 | x |
| example 45 | | | | 1η | | | | | |
| Comparative | 1.382 | 2.739 | 0.505 | 3δ, 3ξ | x | x | | 0.7036 | x |
| example 46 | | | | | | | | | |
| Comparative | 1.573 | 2.942 | 0.535 | 3δ, 2ξ, | x | | x | 0.7164 | x |
| example 47 | | | | 1η | | | | | |

From evaluation results in Table 13, compared with previous steel plates (comparative examples), the hot-dip galvanized steel plate (experimental examples) obtained by adjusting high-span temperature of the cooling section to 210-220°, but keeping other processes unchanged in the hot-dip galvanization process was characterized in that Al/Zn ratios of the Fe-Al intermediate transition layers of the plating layers were 0.757-0.884, δ phase and ξ phase of the plating layers obviously reduced, and η phase of the pure zinc layers increased, thus significantly improving anti-drop performance, scratch resistance and wear resistance of the plating layers, and obviously improving adhesion between the plating layers and the base steel.

What is claimed is:

1. A hot-dip galvanized steel plate, a Fe-Al intermediate transition layer being positioned between a base steel and a plating layer, characterized in that atomic concentration ratio Al/Zn of Al and Zn in the Fe-Al intermediate transition layer is 0.9-1.2.

2. The hot-dip galvanized steel plate according to claim 1, characterized in that intensity of grain orientation Zn(002) peak of the plating layer is 25000-35000 cts.

3. A production method of a hot-dip galvanized steel plate, comprising pickling and annealing a steel plate for hot-dip galvanization operation, and characterized in that During the hot-dip galvanization operation, temperature of the steel plate is 455-485° while being sent to plating bath, temperature of the plating bath in a zinc pot is 450-460°, weight percentage of Fe in the plating bath is less than 0.03%, weight percentage of Al in the plating bath is 0.16-0.25%, high-span temperature of a cooling section is 210-245°, and cooling rate of the steel plate is 0-90%.

4. The production method of a hot-dip galvanized steel plate according to claim 3, characterized in that During the hot-dip galvanization operation, the temperature of the steel plate is 455-465° while being sent to the plating bath, the temperature of the plating bath in the zinc pot is 450-460°, the weight percentage of Fe in the plating bath is less than 0.03%, the weight percentage of Al in the plating bath is 0.16-0.18%, speed of a unit is 100-110 m/min, the high-span temperature of the cooling section is 210-220°, and the cooling rate of the steel plate is 0%.

5. The production method of a hot-dip galvanized steel plate according to claim 3, characterized in that During the hot-dip galvanization operation, the temperature of the steel plate is 475-485° while being sent to the plating bath, the temperature of the plating bath in the zinc pot is 450-460°, the weight percentage of Fe in the plating bath is less than 0.03%, the speed of the unit is 100-110 m/min, the cooling rate of the steel plate is 0%, the high-span temperature of the cooling section is 235-245°, and the weight percentage of Al in the plating bath is not less than 0.16% but not more than 18%.

6. The production method of a hot-dip galvanized steel plate according to claim 3, characterized in that During the hot-dip galvanization operation, the temperature of the steel plate is 475-485° while being sent to the plating bath, the temperature of the plating bath in the zinc pot is 450-460°, the weight percentage of Fe in the plating bath is less than 0.03%, the weight percentage of Al in the plating bath is more than 0.18% but not more than 0.21%, the speed of the unit is 100-110 m/min, the cooling rate of the steel plate is 0%, and the high-span temperature of the cooling section is 235-245°.

7. The production method of a hot-dip galvanized steel plate according to claim 3, characterized in that During the hot-dip galvanization operation, the temperature of the steel plate is 455-465° while being sent to the plating bath, the temperature of the plating bath in the zinc pot is 450-460°, the weight percentage of Fe in the plating bath is less than 0.03%, the weight percentage of Al in the plating bath is 0.16-0.18%, the speed of the unit is 110-120 m/min, and the steel plate is forcibly cooled by air cooling at the cooling rate of 70-90% after being taken out of the zinc pot.

8. The production method of a hot-dip galvanized steel plate according to claim 3, characterized in that During the hot-dip galvanization operation, the temperature of the steel plate is 455-465° while being sent to the plating bath, the temperature of the plating bath in the zinc pot is 450-460°, the weight percentage of Al in the plating bath is 0.21-0.25%, the weight percentage of Fe in the plating bath is less than 0.03%, the speed of the unit is 100-110 m/min, the cooling rate of the steel plate is 0%, and the high-span temperature of the cooling section is 235-245°.

9. The production method of a hot-dip galvanized steel plate according to any of claims 3 to 8, characterized in that based on weight percentage, the steel plate to be galvanized contains 0.03-0.07% of C, 0.01-0.03% of Mn, 0.19-0.30% of Si, 0.006-0.019% of P, 0.009-0.020% of S, 0.02-0.07% of Al and Fe.

10. The production method of a hot-dip galvanized steel plate according to any of claims 3 to 8, characterized in that thickness of the steel plate to be galvanized is 0.8 mm.

11. The production method of a hot-dip galvanized steel plate according to any of claims 3 to 8, characterized in that weight of a zinc layer is 180-195 g/m² after the steel plate to be galvanized is galvanized, and surface of the zinc layer is subject to SiO₂ passivation treatment.
